(19) United States
(12) Patent Application Publication
(10) Pub. No.: US 2015/0378600 A1
(43) Pub. Date: Dec. 31, 2015

(54) CONTEXT MENU UTILIZING A CONTEXT INDICATOR AND FLOATING MENU BAR

(71) Applicant: MICROSOFT TECHNOLOGY LICENSING, LLC, REDMOND, WA (US)

(72) Inventors: Ryan Sloan, Seattle, WA (US); Jon Esterly, Woodinville, WA (US); Maya Rodrig, Seattle, WA (US); Il Yeo, Bellevue, WA (US); Timothy Long, Woodinville, WA (US); Matthew Vogel, Seattle, WA (US); Julie Seto, Duvall, WA (US); Jon Bell, Seattle, WA (US)

(21) Appl. No.: 14/751,080

(22) Filed: Jun. 25, 2015

Related U.S. Application Data
(60) Provisional application No. 62/018,480, filed on Jun. 27, 2014.

(51) Int. Cl. G06F 3/0488; G06F 3/0484; G06F 3/0482

(52) U.S. Cl. CPC G06F 3/04886; G06F 3/0482; G06F 3/04842

(57) ABSTRACT

A context menu in an application user interface displays a context indicator in response to user interaction that places an insertion pointer or selects content in the application user interface. The context indicator is configured to invoke a floating menu having a set of contextual commands. The contextual commands of the floating menu include a parent command that is configured to open a submenu. The submenu includes a plurality of submenu commands associated with the parent command. The context menu displays a selectable button appended to the context indicator without presenting the underlying floating menu and submenu. The selectable button is configured to execute a predicted command that corresponds to one of a contextual command of the floating menu or a submenu command of the submenu.

### CROSS-REFERENCE TO RELATED APPLICATIONS

This patent application claims priority to U.S. provisional patent application Ser. No. 62/018,480 titled “CONTEXT MENU UTILIZING A CONTEXT INDICATOR AND FLOATING MENU BAR” which was filed on Jun. 27, 2014 and which is expressly incorporated herein by reference in its entirety.

### BACKGROUND

When viewing a word processing document on a computing device, a user may execute various commands by interacting with a set of tabbed toolbars known as a ribbon. A user also may execute a Left-Click command to place a cursor or a Left-Click-and-Hold command to select text. After the cursor is placed, the user may execute a Right-Click command to be presented with a floating menu that includes a subset of certain commands available in the ribbon.

Floating menus for desktop applications typically contain numerous and duplicative commands and not suitable on smaller form factors as large user interfaces occlude important on-screen real estate. Additionally, it is not practical to make functionality available only via Right-Click commands for touchscreen devices.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

A context menu in an application user interface displays a context indicator in response to user interaction that places an insertion pointer or selects content in the application user interface. The context indicator is configured to invoke a floating menu having a set of contextual commands. The contextual commands of the floating menu include a parent command that is configured to open a submenu. The submenu includes a plurality of submenu commands associated with the parent command. The context menu displays a selectable button appended to the context indicator without presenting the underlying floating menu and submenu. The selectable button is configured to execute a predicted command that corresponds to one of a contextual command of the floating menu or a submenu command of the submenu.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 illustrates an embodiment of an exemplary architecture in accordance with aspects of the described subject matter.

FIGS. 2A-E illustrate exemplary context menu implementations in accordance with aspects of the described subject matter.

FIGS. 3A-H illustrate exemplary context menu implementations in accordance with aspects of the described subject matter.

FIGS. 4A and 4B illustrate exemplary context menu implementations in accordance with aspects of the described subject matter.

FIGS. 5A-C illustrate exemplary context menu implementations in accordance with the described subject matter.

FIGS. 6A-H illustrate exemplary context menu implementations in accordance with the described subject matter.

FIG. 7 illustrates an embodiment of an exemplary process in accordance with aspects of the described subject matter.

FIG. 8 illustrates an embodiment of an exemplary operating environment that can implement aspects of the described subject matter.

FIG. 9 illustrates an embodiment of an exemplary mobile computing device that can implement aspects of the described subject matter.

### DETAILED DESCRIPTION

The detailed description provided below in connection with the appended drawings is intended as a description of examples and is not intended to represent the only forms in which the present examples may be constructed or utilized. The description sets forth functions of the examples and sequences of steps for constructing and operating the examples. However, the same or equivalent functions and sequences may be accomplished by different examples.

References to “one embodiment,” “an embodiment,” “an example embodiment,” “one implementation,” “an implementation,” “one example,” “an example” and the like, indicate that the described embodiment, implementation or example may include a particular feature, structure or characteristic, but every embodiment, implementation or example may not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic may be implemented in connection with other embodiments, implementations or examples whether or not explicitly described.

Numerous specific details are set forth in order to provide a thorough understanding of one or more aspects of the described subject matter. It is to be appreciated, however, that such aspects may be practiced without these specific details. While certain components are shown in block diagram form to describe one or more aspects, it is to be understood that functionality performed by a single component may be performed by multiple components. Similarly, a single component may be configured to perform functionality described as being performed by multiple components.

Various aspects of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

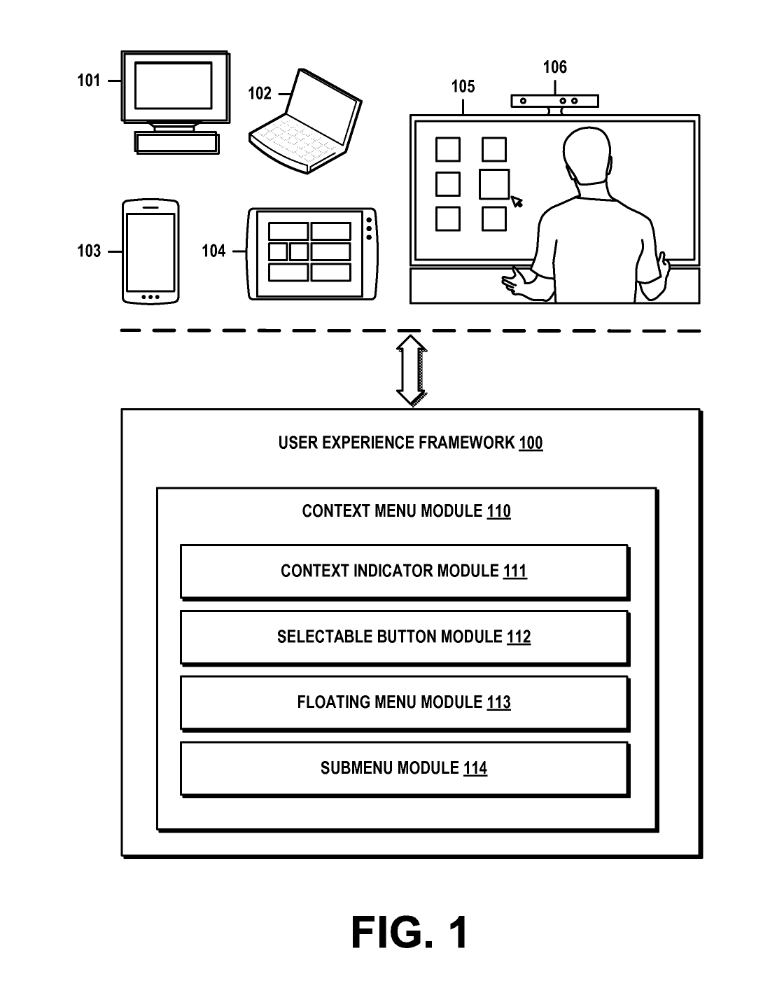

FIG. 1 illustrates a user experience framework 100 as an embodiment of an exemplary architecture in accordance with aspects of the described subject matter. It is to be appreciated that user experience framework 100, or portions thereof, can be implemented by various computing devices and can be implemented by software, hardware, firmware or a combination thereof in various embodiments.

Implementations of user experience framework 100 are described in the context of a computing device and/or a computer system configured to perform various steps, methods, and/or functionality in accordance with aspects of the described subject matter. It is to be appreciated that a computer system can be implemented by one or more computing devices. Implementations of user experience framework 100 also are described in the context of “computer-executable instructions” that are executed to perform various steps, methods, and/or functionality in accordance with aspects of the described subject matter.

In general, a computing device and/or computer system can include one or more processors and storage devices (e.g., memory and disk drives) as well as various input devices, output devices, communication interfaces, and/or other types of devices. A computing device and/or computer system also can include a combination of hardware and software. It can be appreciated that various types of computer-readable storage media can be part of a computing device and/or computer system. As used herein, the terms “computer-readable storage media” and “computer-readable storage medium” do not mean and unequivocally exclude a propagated signal, a modulated data signal, a carrier wave, or any other type of transitory computer-readable medium. In various implementations, a computing device and/or computer system can include a processor configured to execute computer-executable instructions and a computer-readable storage medium (e.g., memory and/or additional hardware storage) storing computer-executable instructions configured to perform various steps, methods, and/or functionality in accordance with aspects of the described subject matter.

Computer-executable instructions can be embodied and/or implemented in various ways such as by a computer program (e.g., client program and/or server program), a software application (e.g., client application and/or server application), software code, application code, source code, executable files, executable components, program modules, routines, application programming interfaces (APIs), functions, methods, objects, properties, data structures, data types, and/or the like. Computer-executable instructions can be stored on one or more computer-readable storage media and can be executed by one or more processors, computing devices, and/or computer systems to perform particular tasks or implement particular data types in accordance with aspects of the described subject matter.

User experience framework 100 can be implemented by one or more computing devices, such as client devices 101-106. Client device 101 is shown as a personal computer (PC). Client device 102 is shown as a laptop computer. Client device 103 is shown as a smartphone. Client device 104 is shown as a tablet device. Client device 105 and client device 106 are shown as a television and a media device (e.g., media and/or gaming console, set-top box, etc.). It is to be understood that the number and types of client devices 101-106 are provided for purposes of illustration. User experience framework 100 also can be implemented by one or more computing devices of a computer system configured to provide server-hosted, cloud-based, and/or online services in accordance with aspects of the described subject matter.

In implementations where user-related data is utilized, user experience framework 100 and/or computing devices (e.g., client devices 101-106, computing devices of a computer system, etc.) that provide and/or support user experience framework 100 can employ a variety of mechanisms in the interests of user privacy and information protection. Such mechanisms can include, without limitation: requiring authorization to monitor, collect, or report data; enabling users to opt in and opt out of data monitoring, collecting, and reporting; employing privacy rules to prevent certain data from being monitored, collected, or reported; providing functionality for anonymizing, truncating, or obfuscating sensitive data which is permitted to be monitored, collected, or reported; employing data retention policies for protecting and purging data; and/or other suitable mechanisms for protecting user privacy.

As shown in FIG. 1, user experience framework 100 can include one or more computer program modules configured for implementing a context menu. In one embodiment, the context menu is a proximal contextual user interface surface composed of: a context indicator, a floating command bar, and one or more submenus. Computer program modules of user experience framework 100 can be implemented by computer-executable instructions that are stored on one or more computer-readable storage media and that are executed to perform various steps, methods, and/or functionality in accordance with aspects of the described subject matter. While such computer program modules are shown in block diagram form to describe certain functionality, it is to be understood that the functionality performed by a single computer program module can be performed by multiple computer program modules and that a single computer program module can be configured to perform functionality described as being performed by multiple computer program modules.

Context menu module 110 can be configured to implement a context menu for an application user interface. In general, the context menu is designed as a predictable toolkit to present a small set of contextual commands that are relevant to a user's interaction with document content displayed by an application program. The context menu can be implemented for various applications including, but not limited to: word processing applications, spreadsheet applications, slideshow presentation applications, note taking applications, email applications, text messaging applications, and other types of applications that enable users to select, author, and/or edit content. For a particular application, the context menu can be implemented for various contexts related to insertion pointer placement and/or content selection.

The context menu and/or parts thereof can be implemented by or for an application that operates in various modes (e.g., reading mode, editing mode, slideshow mode) or orientations (e.g., portrait view, landscape view, a 50/50 view) and can be designed to provide consistent appearance and functionality in multiple modes and/or multiple orientations. The context menu and/or parts thereof can be implemented by or for an application that operates across various touchscreen devices (e.g., desktop, laptop, tablet, mobile phone) and/or form factors and can be designed to provide consistent appearance and functionality across multiple touchscreen devices and/or multiple form factors. The context menu and/or parts thereof can be implemented by or for an application that operates across various operating systems (e.g., a Microsoft® Windows ® operating system, a Google® Android™ operating system, an Apple iOS™ operating system) and can be designed to provide consistent appearance and functionality across multiple operating systems. The context menu and/or parts thereof can be implemented by or for different applications that are responsive to a particular context (e.g., insertion pointer placement, content selection) and can be designed to provide consistent appearance and functionality for the particular context across the different applications. The context menu can avoid complex nesting and navigation so that it is easy for users to form expectations around the contents of the context menu and where they should go to execute commands. The context menu can be utilized by user interfaces provided on desktop, touchscreen, and/or mobile devices and can be implemented across various form factors, architectures, and/or applications.

Context indicator module 111 can be configured to implement and/or display a context indicator in an application user interface. The context indicator can be implemented as a selectable object (e.g., box, button, graphic, icon, UI surface, etc.) that appears near a user's insertion pointer (IP) or selection. The context menu can be configured to present the context indicator in response to a user placing an insertion pointer or making a selection by tapping within document content. The context indicator can be implemented by a single, small selectable object that overlays document content in proximity to a user's touch point, an insertion pointer, selected text, and/or a selected object. In general, only one context indicator will be able to appear at a given point in time. In some implementations, the context indicator can be used alone in response to insertion pointer placement or a user selection.

The context indicator can display an icon (e.g., a text character such as an ellipsis or letter, a symbol, an image, etc.) to indicate or represent that user is able to access commands for contextually-related functions. In some implementations, the icon displayed or presented inside the context indicator can change based on and/or to indicate a current context. Examples of current context include, without limitation: text—IP placement, text—selection, text—marked word selection, text—hyperlink or linked text selection, image—selection, table—IP placement, table—selection, table—row selection, table—column selection, table—text selection, smart art—selection, shape—selection, multiple objects—selection, chart—selection, spreadsheet cell—selection, spreadsheet cell range—selection, slide thumbnail—selection, numbered list—number selection, calendar item—selection, and the like.

Invocation and dismissal of the contextual indicator can be controlled by show/hide logic. For example, the context indicator can be invoked and appear when the user's current insertion pointer placement or selection is within in an editable user interface surface, such as the in-canvas region of a document presented within an application user interface. The context indicator can appear for in-canvas content when the insertion pointer is placed, when a selection is made, or when the user taps the insertion pointer. In some implementations, tapping an editable surface places the insertion pointer, tapping the insertion pointer or a word adjacent to the insertion pointer moves from the insertion pointer state to a selected state (e.g., word selection), and tapping a selected word moves from the selected state to the insertion pointer state. The context indicator can be used in various scenarios such as for in-canvas selections, cell selections, and other selections that do not have a primary action associated with tap. It can be appreciated that invoking the context indicator can be avoided, blocked, or overridden for certain selections where a tap is associated with an existing primary action that users expect (e.g., tap slide thumbnail to navigate to slide, tap message in mail list to display message in reading pane, and the like).

The context indicator can disappear or hide when the user begins typing. In other words, typing content can manually dismiss the context indicator. After typing, the user can bring the context indicator back by making a selection, placing the insertion pointer elsewhere, or tapping on a word that was just typed. The context indicator can hide when the user pans and can return when panning stops, if the user's current insertion pointer or selection is still visible on screen. The context indicator can hide when another transient user interface surface is invoked and can return when such transient user interface surface is dismissed. In addition, the context indicator is not shown when the user's selection or insertion pointer is not on-screen, for example, when the user scrolls such that the selection/insertion pointer is no longer visible.

The context indicator's position can be set per context and per application. In response to the user's current insertion pointer or selection, the application can provide information including the anchor point and current context. The control for the context indicator can define positioning logic for the context relative to the anchor point. The control for the context indicator can be coordinated with respect to an application and/or across applications to ensure consistent placement for consistent contexts.

An application can specify or request positioning in a particular region relative to the anchor point or anchor rectangle. The positions include: upper-left, left, lower-left, above, below, upper-right, right, and lower right. For text or other in-line content (e.g., table cells, etc.), the context indicator generally will be positioned to the lower-right of the user's current insertion pointer or selection. Positioning the context indicator to the lower-right of text and/or cells is less likely to occlude relevant content. For objects (e.g., images, entire tables, shapes, etc.), the context indicator will be positioned by default to the upper-right of the current selection as users are more likely to select objects near the top. If, at a particular moment, the context indicator would not be visible on screen at the position requested by the application, positioning of the context indicator falls back in another direction to a position where the context indicator is visible.

Selectable button module 112 can be configured to implement and/or display a selectable button appended to the context indicator in an application user interface. In one implementation, the context indicator can be appended to a selectable command which can be, for example: a command most-frequently used by a community of users and/or the user, a most-recently used command, a predicted command, a default command, and the like. In some implementations, multiple selectable buttons can be appended to the context indicator.

Floating menu module 113 can be configured to implement and/or display a floating menu in an application user interface. In one implementation the floating menu is implemented as a floating command bar. In response to the user tapping the context indicator, the user can be presented with the floating command bar including a small set of commands believed to be highly relevant to the context.

When the user taps the context indicator, the floating command bar replaces the context indicator. In general, the context indicator will always be hidden when the floating command bar is invoked. By default, the floating command bar can be positioned on top of the context indicator extending out to the right in cases where the floating command bar will be visible on the screen. In cases where the floating command bar would not be visible (e.g., occluded by the virtual keyboard, positioned off-screen, etc.) when extending to the right, the floating command bar can be displayed at various fallback positions and extended in other directions so that the floating command bar is visible. The floating command bar can be configured so that it is entirely visible on a 7″ tablet in portrait view and landscape view, entirely visible on a 10″ tablet in 50/50 view, and/or entirely visible on a mobile phone having a 480 pixel device-width.

In terms of balancing discoverability, efficiency, and content occlusion, invocation of the floating command bar via selection of the context indicator provides advantages over press-and-hold invocation or direct invocation on insertion pointer placement or selection. With respect to press-and-hold invocation, such functionality is difficult to discover unless there is no other visible on-screen user interface surface. Namely, when the ribbon is present, users typically do not attempt to invoke functionality via a press-and-hold command. In addition to initial discoverability, users have recall problems for hidden user interface surfaces.

With respect to direct invocation of the floating command bar upon insertion pointer placement or selection, care must be taken to avoid distracting the user and occluding relevant document content as the floating command bar is larger than the context indicator. While selecting the context indicator involves an extra touch, there is almost no perceivable loss in efficiency.

In addition to being invoked by selection of the context indicator, the floating command bar can be invoked in other ways as well. For example, the floating command bar can be invoked at the point of invocation by a press-and-hold command or by a right-click command. The floating command bar also can be invoked and anchored to the current insertion pointer or selection by a Shift+F10 command.

In some implementations, the context indicator can be bypassed and the floating command bar can be invoked upon insertion pointer placement or selection in certain scenarios, such as high confidence scenarios. Predicted user behavior can be determined using one or more machine learning techniques such as: supervised learning techniques (e.g., Support Vector Machine (SVM), Conditional Random Fields (CRFs), decision tree (e.g., boosted, bootstrap aggregated, ensemble, random forest, and the like), k-Nearest Neighbors (k-NN), Naive Bayes, Bayesian networks, neural networks, logistic regression, and the like); unsupervised learning techniques (e.g., clustering (e.g., k-mean, mixture model, hierarchical, and the like), hidden Markov models, blind signal separation, and the like); semi-supervised learning techniques; data mining techniques; and/or other artificial intelligence and/or machine learning techniques. Such techniques can be employed for calculating probabilities of intended user actions and/or commands, predicting a command corresponding to a command from a floating menu or an underlying submenu, determining whether to bypass the context indicator and automatically display the floating menu and/or the underlying submenu, and/or determining whether to display a selectable button appended to the context indicator that is configured to invoke a predicted command.

The floating command bar can contain buttons that execute an action, open a submenu, or launch another command surface separate from the context menu. The floating command bar can support control button and split buttons. Buttons can be labeled and can provide tooltips upon execution of a press-and-hold command. The floating command bar can support keyboard actions such as arrow keys or tab keys for moving through the floating command bar, a space bar command for opening a submenu, and/or accelerator keys.

The floating command bar generally will be configured to hold only a small set of very high-frequency contextual commands. While there is not a hard restriction placed on the number of commands, typically the floating command bar will be designed to contain only a few (e.g., no more than 7) contextual commands at any given time. In some implementations, commands can be ordered in the floating command bar as follows: global commands, contextual commands, and then pane/tab launcher commands.

The commands included in the floating command bar typically will be selected as the top commands believed or predicted to be the most relevant to the user or a community of users. It can be appreciated that the effectiveness of the floating command bar may decrease if too many commands are included or added. Accordingly, there is a bias to only including highly-relevant commands so that the context menu does not overly duplicate commands provided in other user interface surfaces such as a ribbon.

Rather than duplicating or replacing functionality of the ribbon, the context menu can complement the ribbon by mitigating some weaknesses. For example, some ribbon tabs are modal and some tasks require frequent tab-switching or command loops. The context menu and the floating command bar can be designed to help users minimize detours and avoid paying the cost of tab-switching. The context menu can reduce command loops by presenting high frequency, less modal commands proximally and/or by serving as a launching point to a non-proximal contextual user interface. Less modal commands include commands that require a tab switch, but are often followed by switching right back. A non-proximal contextual user interface can include a user interface surface that is contextually relevant to the user interaction and provided within the current application (e.g., fixed contextual user interface) and/or by a different application.

The selection of the commands included in the floating command bar can be determined from and/or based on frequency metrics such as service quality management (SQM) metrics or other usage metrics. For example, a provider of one or more applications can accumulate usage data from one or more groups of testers to determine which application commands are most frequently used. The provider can then develop and integrate the context menu into one or more applications so that the most frequently used commands (e.g., cut, cop, paste) are easily accessible via the floating command bar and other highly used commands (e.g., light-weight formatting tasks such as bolding, font size and font color) are also easily accessible via other user interface surfaces in various use scenarios.

For purposes of illustration and not limitation, the following table shows exemplary contexts and commands that can be used to implement aspects of the described subject matter.

Context/Commands Table

| Context | Commands |
|---|---|
| Text | Paste |
| | Copy |
| | Delete |
| | Comment |
| | Proofing |
| Image | Paste |
| | Copy |
| | Delete |
| | Comment |
| | Crop |
| | Wrap Text |
| Insertion | Paste |
| Pointer in | Copy |
| Table | Delete |
| | Row |
| | Column |
| | Contents |
| | Comment |
| | Proofing |
| | Insert |
| | Left |
| | Right |
| | Above |
| | Below |
| Entire | Paste |
| Table | Copy |
| | Delete |
| | Comment |
| | Distribute |
| | Rows |
| | Columns |
| Cell | Paste |
| | Copy |
| | Delete |
| | Row |
| | Column |
| | Contents |
| | Comment |
| Cell Range | Paste |
| | Copy |
| | Delete |
| | Row |
| | Column |
| | Contents |
| | Comment |
| | Merge |
| | Merge and Center |
| | Merge Across |
| | Merge Cells |
| | Unmerge Cells |
| Slide | Paste |
| Thumbnail | Copy |
| | Delete |
| | Duplicate |
| | Hide/Show |
| Linked | Paste |
| Text | Copy |
| | Delete |
| | Comment |
| | Hyperlink |
| | Proofing |
| Shape | Paste |
| | Copy |
| | Delete |
| | Comment |
| Objects | Paste |
| (multiple) | Copy |
| | Delete |
| | Comment |
| | Group/Ungroup |
| Number on | Paste |
| Numbered | Copy |
| List | Delete |
| | Restart at 1 |
| Calendar | Delete |
| Item | Repeat |
| | Categorize/Color |
| | Accept |
| | Tentative |
| | Decline |

The floating command bar can be designed so that the placement or positioning of commands is consistent across multiple contexts within a particular application and is also consistent across multiple contexts for multiple applications. For example, within the floating command bar, a paste command can be designed to have a consistent position (e.g., first button) for multiple contexts (e.g., selection of text, an image, a table, a cell, and a range of cells) and applications (e.g., word processing application, spreadsheet application, and slideshow presentation application).

Submenu module 114 can be configured to implement and/or display a submenu in an application user interface. The floating command bar can contain one or more buttons that open an underlying submenu. The submenus of the floating command bar can be implemented as callouts that contain options or parameters for their parent command. A submenu typically will be designed to nest tightly integrated options associated with a command or exposing parameters for the command. By way of illustration and not limitation: a submenu for a delete button can nest delete row and delete column parameters; a submenu for an insert button can nest above, below, left, and right parameters; and a submenu for a proofing button can nest one or more suggested words and “ignore all” and “add to dictionary” options. A submenu can host various types of content (e.g., XAML content) but generally will include only content that is closely tied to the parent command to avoid introducing complex navigation or nesting.

A submenu can be invoked and displayed when the user taps a button (e.g., parent command button) of the floating command bar that is associated with the submenu. By default, the submenu can be positioned below the floating command bar. In cases where the submenu bar would not be visible (e.g., occluded by the virtual keyboard, positioned off-screen, etc.) if positioned below the floating command bar, the submenu can be opened at various fallback positions so that the submenu is visible. For example, the submenu can be opened and displayed above the floating command bar in some cases and can overlap the floating command bar in some cases.

In various implementations, an application can define a given context for invoking the floating command bar and/or a submenu. In some contexts, the floating command bar can be invoked and expanded upon insertion pointer placement or selection. For example, the context indicator can be bypassed and the floating command bar can be automatically expanded in scenarios with high confidence such as the user's selecting of an image or the user's selection of an entire row or column, and the like. In scenarios with very high confidence, such as: tapping a marked (misspelled or unrecognized) word, tapping a hyperlink or linked text, accepting/rejecting changes or merging conflicts, and the like, the floating command bar and a submenu can be automatically expanded.

The floating command bar can implement marking menu functionality. For example, the floating command bar can include a single button for clipboard commands that implements menu marking functionality. Rather than displaying all the clipboard commands on the first level of the floating command bar, the clipboard command button can lead to a circular marking menu with four commands (e.g., copy, delete, paste, and cut)—one for each cardinal direction (i.e. north, east, south, and west). The user can swipe in any of these directions to execute the command without having to first tap through the floating command bar to the circular marking menu.

Dismissal of the floating control bar and/or a submenu can be controlled by dismissal logic. In one implementation, for example, light-dismiss logic can enable the floating command bar and/or a submenu to be dismissed without requiring the user to explicitly tap a close button (e.g., X button). When the floating command bar is displayed over document content, a tap outside the bounds of the floating command bar will dismiss the floating command bar. For example, a tap directed to the canvas (e.g., document content that is not occluded by the floating command bar) will dismiss the floating command bar. In this scenario, the tap will be ingested or “eaten” so that the tap does not pass through to the underlying user interface surface. As such, a certain action (e.g., placing an insertion pointer on canvas) that would have been executed, had the tap been received while the floating bar was not displayed, is not executed. When the floating command bar is dismissed, the context indicator can be shown again.

The light-dismiss logic can treat the floating command bar and its submenus as one user interface surface so that when the floating command bar and a submenu are displayed, a tap outside the bounds of the floating command bar and the submenu will dismiss the floating command bar and the submenu together. When a submenu is open, a tap on the parent command button will close the submenu of the parent command button, and a tap on a different command button of the floating command bar will close the submenu of the parent command button and will execute the action of the different command button.

The following exemplary embodiments, implementations, examples, and scenarios are provided to further illustrate aspects the described subject matter. It is to be understood that the following exemplary embodiments, implementations, examples, and scenarios are provided for purposes of illustration and not limitation.

### Exemplary Context Menu Implementations

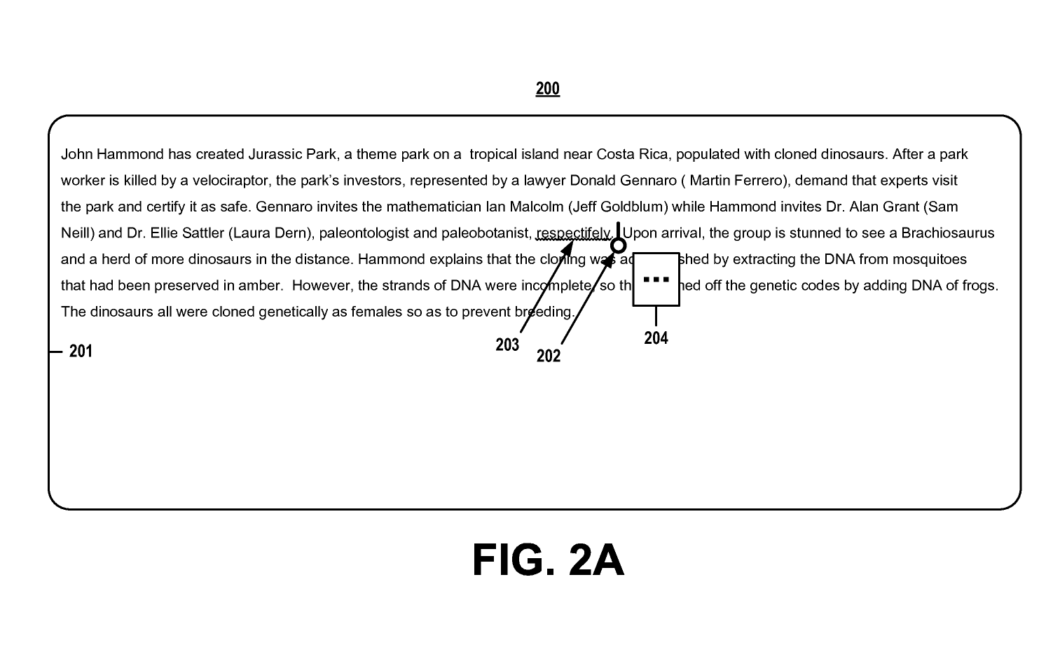

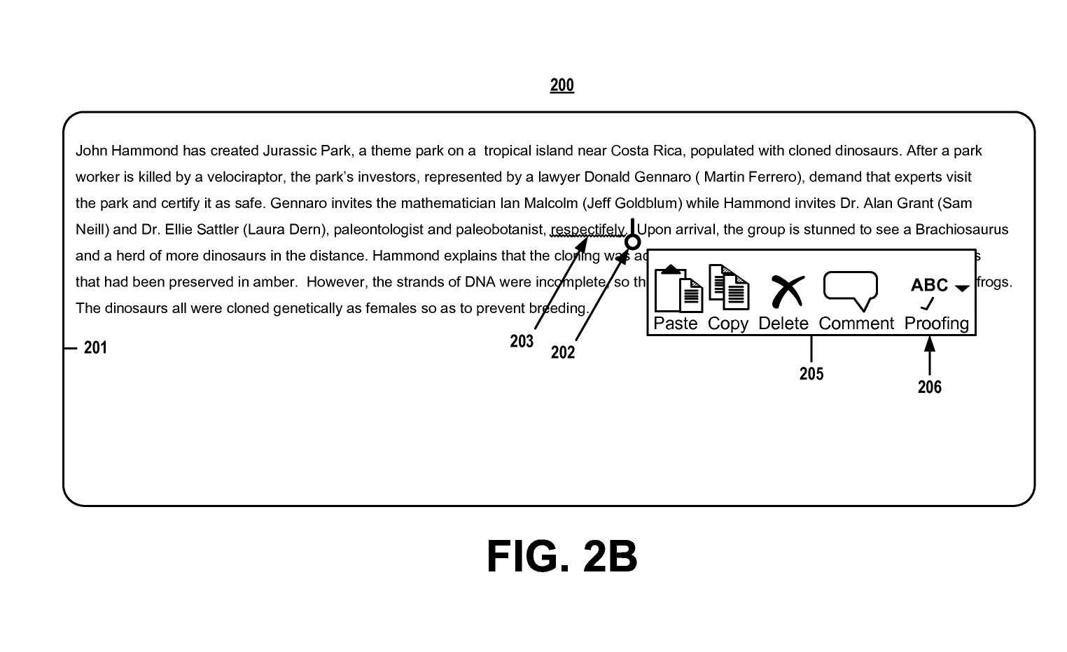

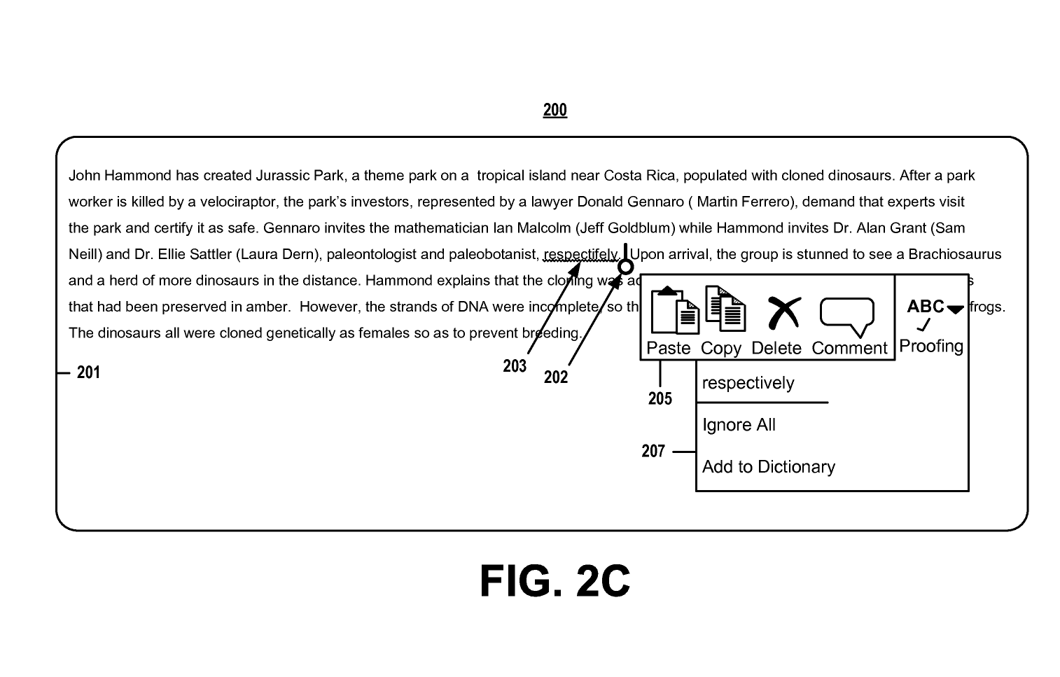

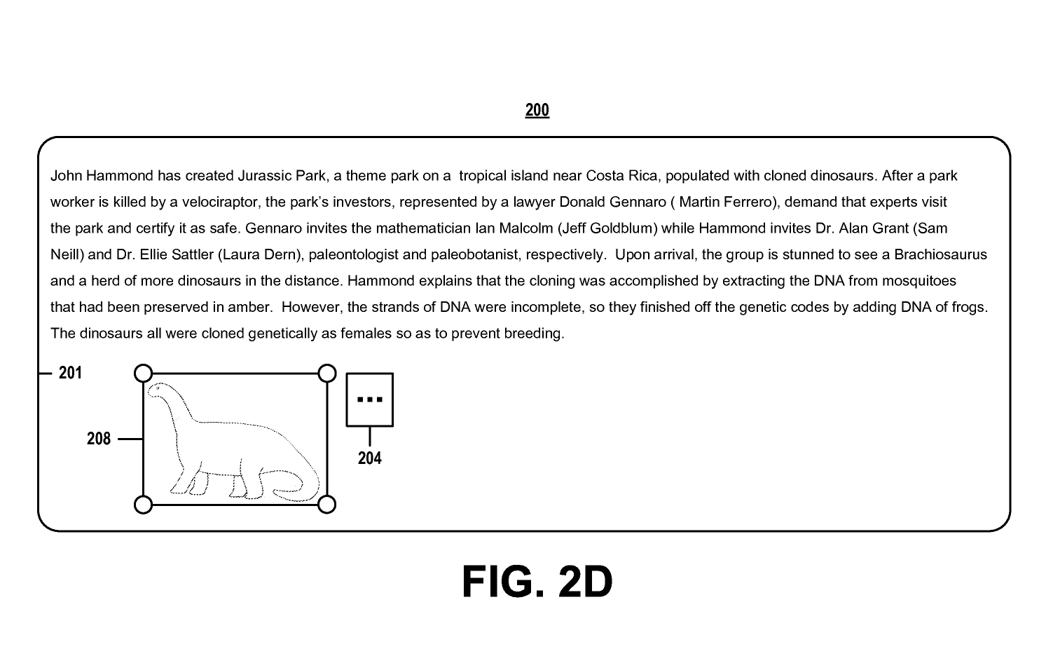

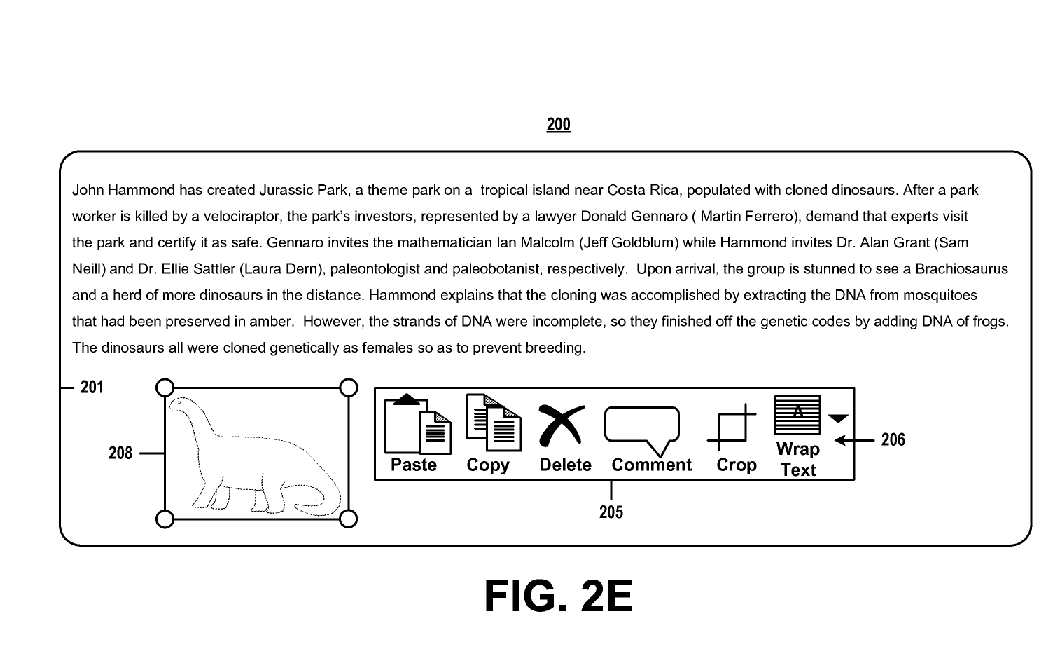

FIGS. 2A-E illustrate exemplary context menu implementations for an application user interface 200 executing on a touchscreen computing device. As shown in FIG. 2A, a document 201 having document content within an editable region is displayed within application user interface 200. A user's placement of an insertion pointer 202 after a misspelled and marked word 203 in document 201 invokes display of a context indicator 204 positioned to the lower-right of insertion pointer 202.

When application user interface 200 and context indicator 204 are displayed as shown in FIG. 2A, a user's selection of context indicator 204 invokes a floating command bar 205 that hides or is positioned over context indicator 204 and extends to the right, as shown in FIG. 2B. An exemplary set of commands provided by floating command bar 205 includes: a paste command, a copy command, a delete command, a comment command, and a proofing command that are implemented by corresponding buttons.

When application user interface 200 and floating command bar 205 are displayed as shown in FIG. 2B, a user's selection of a parent command 206 (e.g., proofing command) invokes a submenu 207, as shown in FIG. 2C. Floating command bar 205 and submenu 207 are displayed near insertion pointer 202 placed after a misspelled and marked word 203. As shown, submenu 207 provides exemplary options or parameters for the proofing command including: a suggested word, an “ignore all” option, and an “add to dictionary” option.

In one implementation, floating command bar 205 is invoked in response the user's selection of context indicator 204, and submenu 207 is invoked in response to the user's selection of parent command 206 (e.g., proofing command). Floating command bar 205 also can be invoked in response a press-and-hold command, a right-click command, and a Shift+F10 command. In some implementations, floating command bar 205 and/or submenu 207 can be automatically invoked upon placement of insertion pointer 202 after the misspelled and marked word 203. For example, tapping the marked (e.g., misspelled or unrecognized) word 203 can be a scenario or context in which there is a very high confidence of user intent and in which context indicator 204 is bypassed and floating command bar 205 and submenu 207 are automatically displayed.

As shown in FIG. 2C, submenu 207 can be positioned below floating command bar 205. In some scenarios, submenu 207 would not be visible (e.g., occluded by a virtual keyboard, positioned off-screen, etc.) if positioned below floating command bar 205. In such scenarios, submenu 207 can be invoked at various fallback positions so that submenu 207 is visible on the touchscreen user interface. In one exemplary scenario, submenu 207 can be opened and displayed above floating command bar 205. In another exemplary scenario, submenu 207 can be opened and displayed to overlap floating command bar 205.

Referring to FIG. 2D, the user can tap the touchscreen user interface to select an object 208 (e.g., image). The user also can execute a press-and-hold command to select object 208 by touching a position of the touchscreen interface corresponding to object 208 for a threshold amount of time. In response to selection of object 208, context indicator 204 is invoked and displayed to the upper-right of object 208.

When application user interface 200 and context indicator 204 are displayed as shown in FIG. 2D, the user can tap the touchscreen user interface to select context indicator 204, and a floating command bar 205 is invoked and displayed adjacent to object 208, as shown in FIG. 2E. An exemplary set of commands provided by floating command bar 205 includes: a paste command, a copy command, a delete command, a comment command, a crop command, and a wrap text command that are implemented by corresponding buttons. Selection of a parent command 206 (e.g., wrap text command) in floating command bar 205 can invoke a submenu.

The user's selection of context indicator 204 invokes floating command bar 205, which hides context indicator 204 and extends to the right. Floating command bar 205 also can be opened near the point of invocation in response to execution of a press-and-hold command or a right-click command. Floating command bar 205 also can be invoked and anchored to the current selection by a Shift+F10 command. Furthermore, floating command bar 205 can be automatically invoked upon selection of object 208 in certain scenarios. For example, the selection of an image can be a scenario or context in which there is a high confidence of user intent and in which invocation of context indicator 204 is bypassed and floating command bar 205 is automatically displayed.

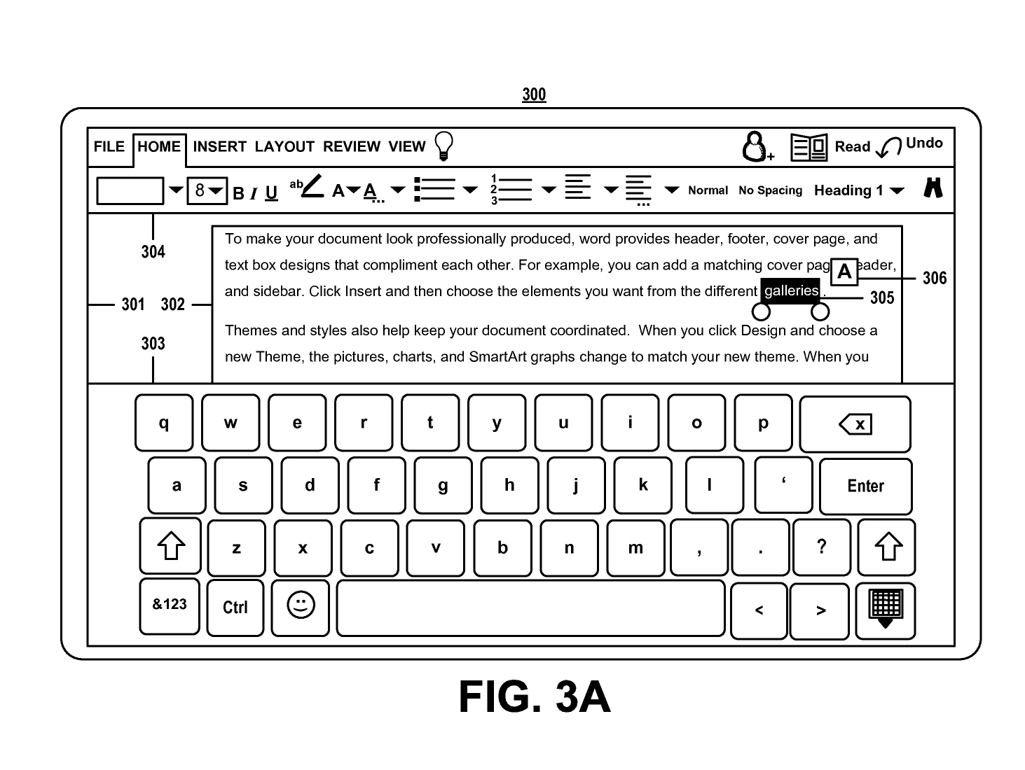

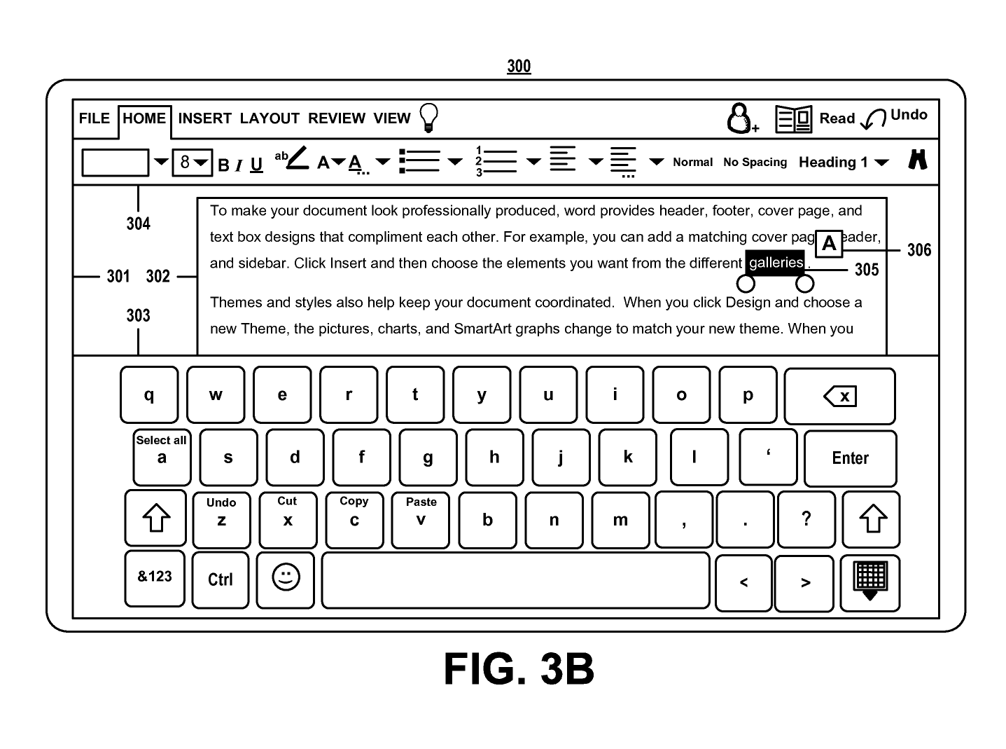

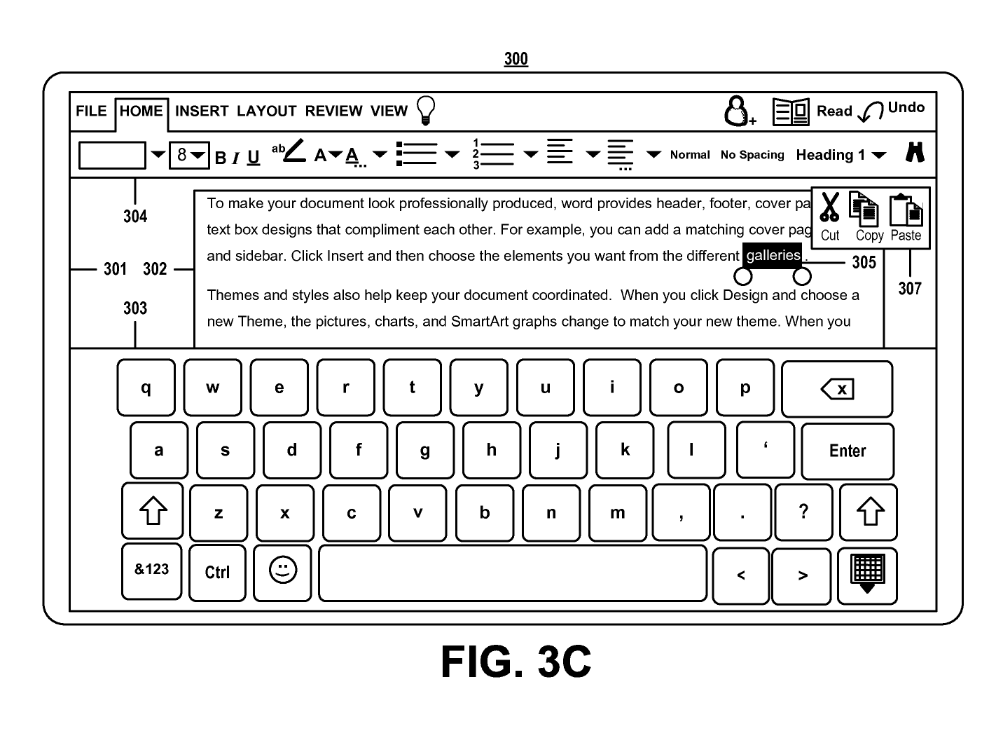

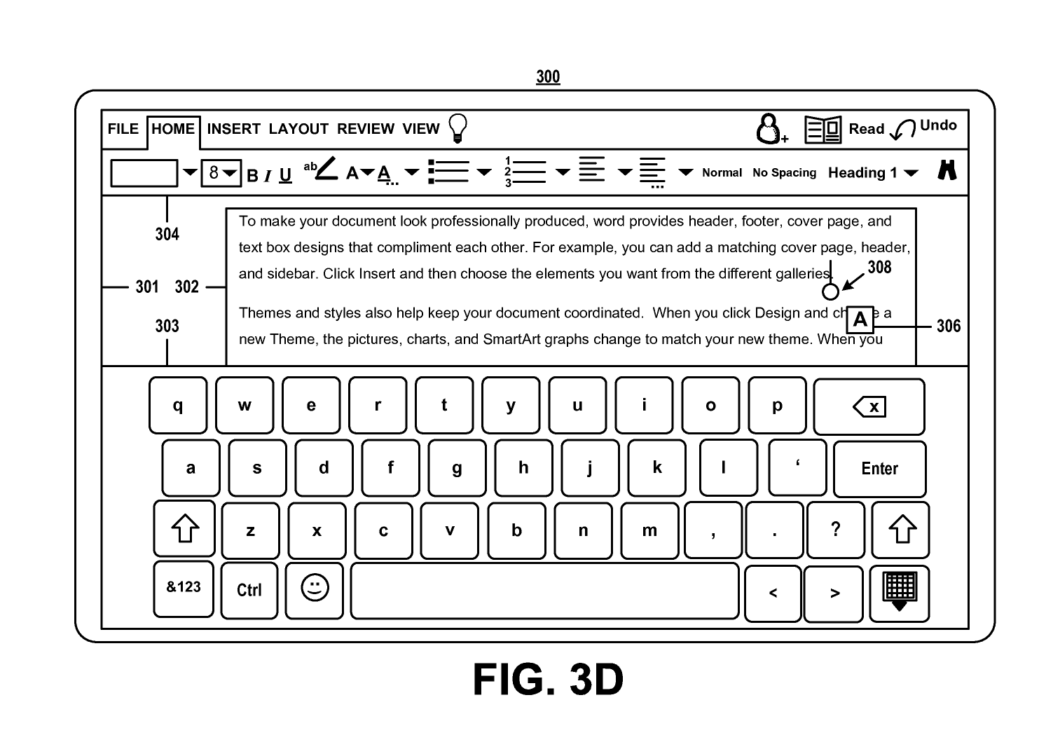

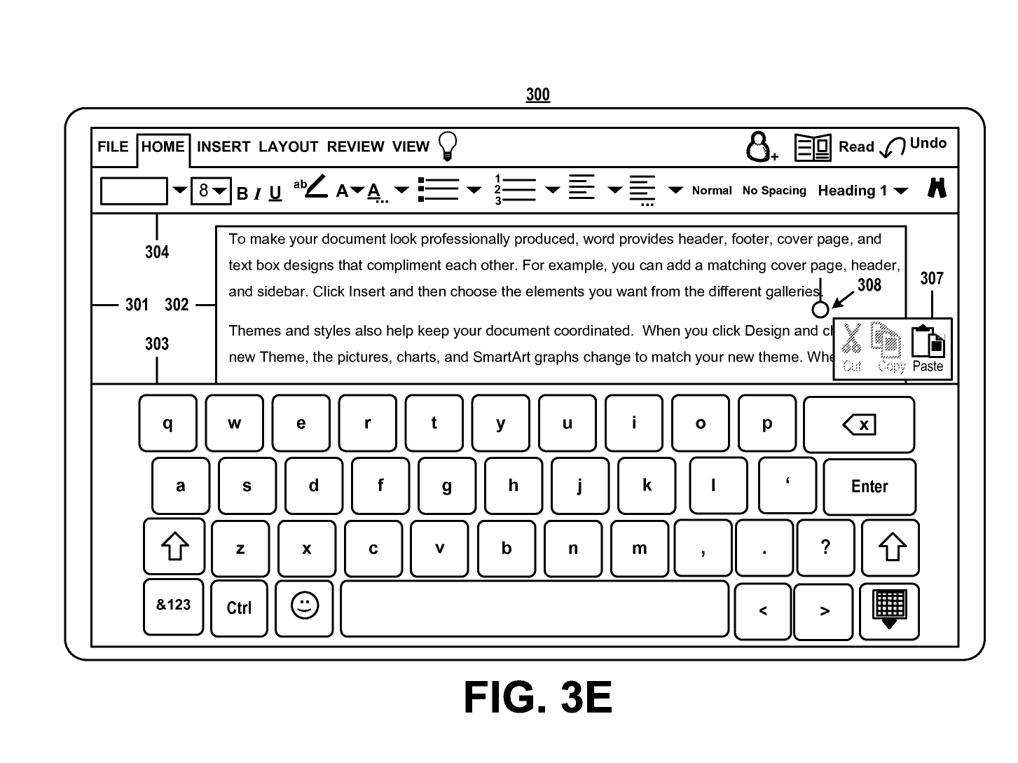

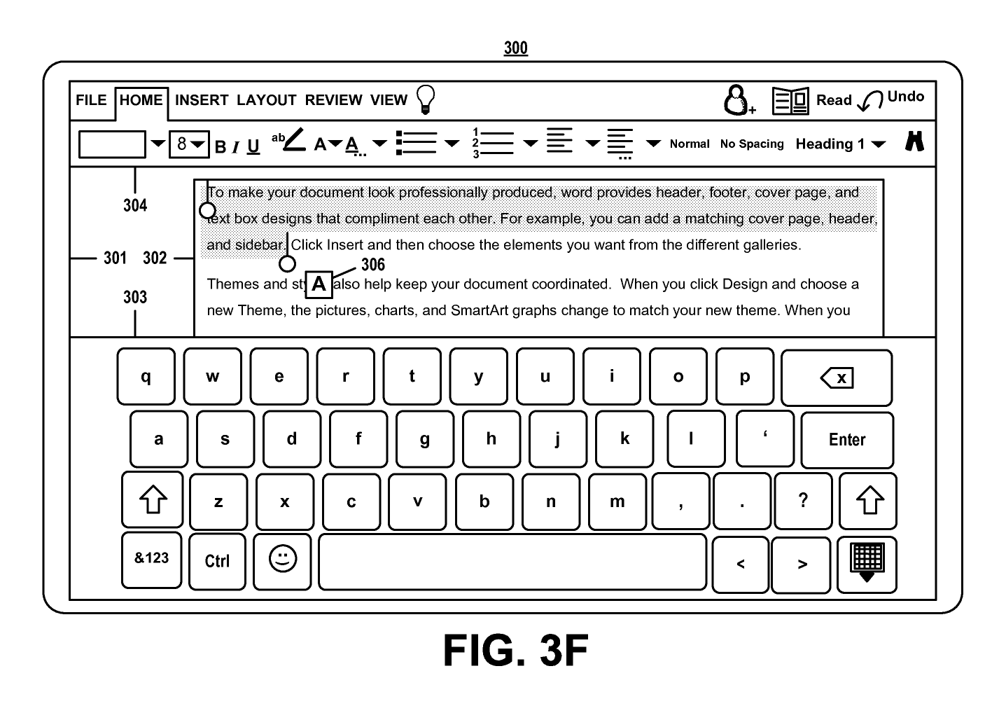

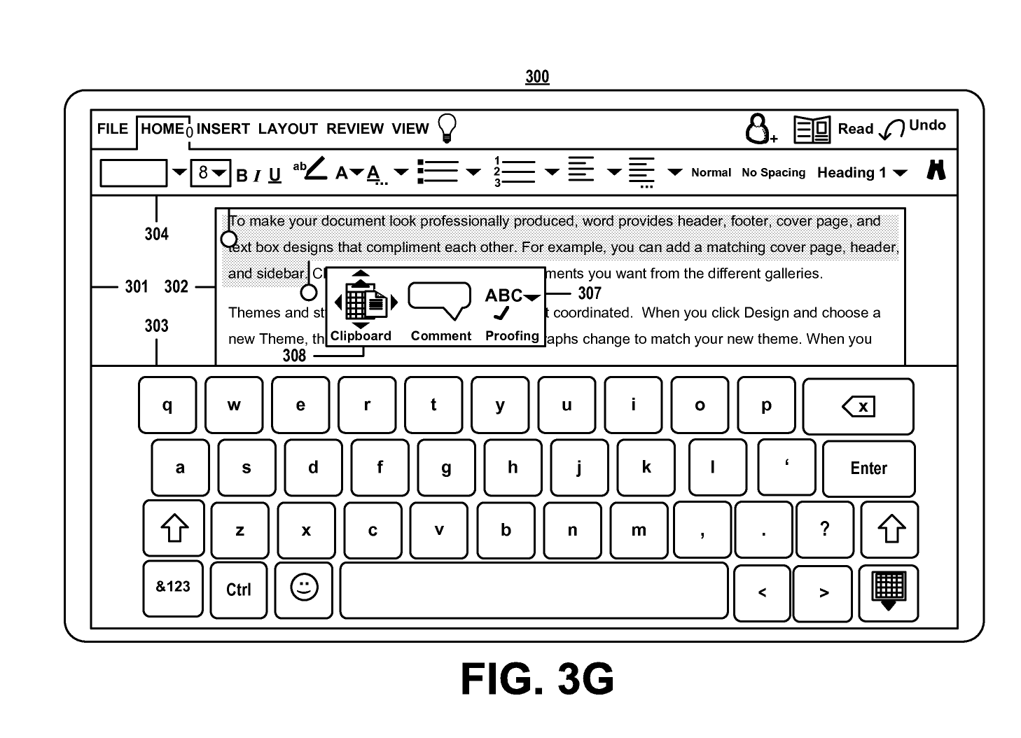

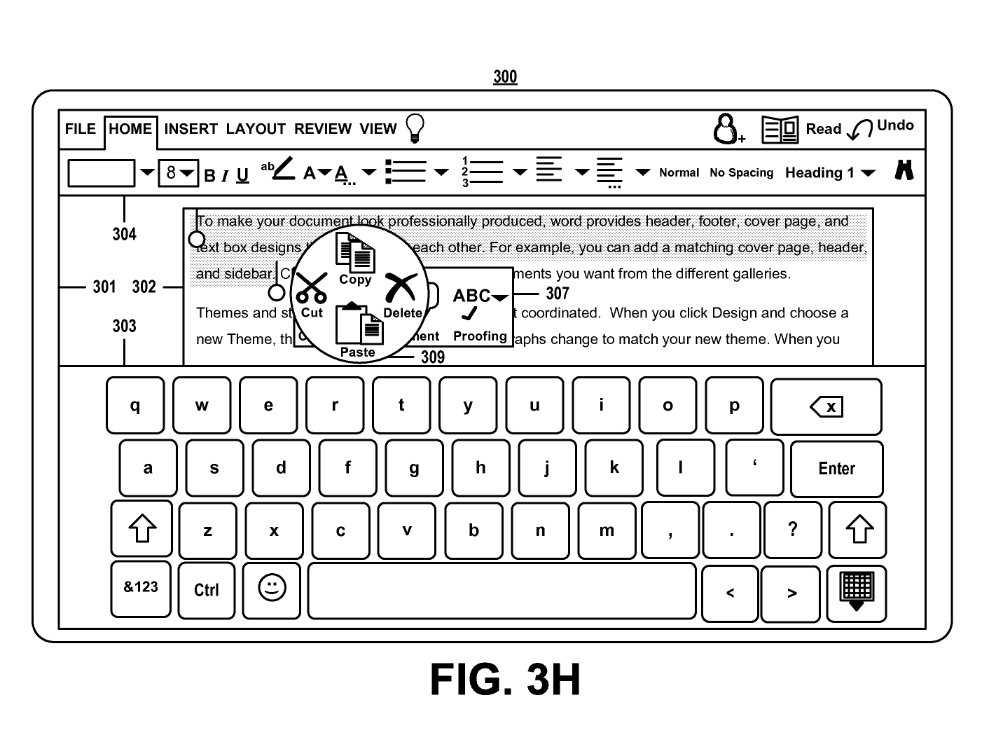

FIGS. 3A-H illustrate exemplary context menu implementations on a touchscreen computing device 300. As shown in FIG. 3A, touchscreen computing device 300 presents an application user interface 301 that displays a document 302 having document content in an editable region, a virtual keyboard 303, and a ribbon 304 having a tabbed set of toolbars. In response selection of a word 305 (e.g., double tapping the word, placing and dragging and insertion pointer) in document 301, a context indicator 306 is presented to the upper-right of the selected word 305.

When application user interface 301 and virtual keyboard 303 are displayed as shown in FIG. 3A, the user can tap a Crtl key of virtual keyboard 303. In response to the user tapping the Ctrl key of virtual keyboard 303, the display of virtual keyboard 303 changes to show certain key commands (e.g., x=cut, c=copy, v=paste) on particular keys of virtual keyboard 303, as shown in FIG. 3B. The user can execute a desired action by tapping a particular key command and/or key on virtual keyboard 303. In one implementation, tapping the Ctrl key is indicative of the user intending to perform a command on the selected word 305 and does not dismiss context indicator 306.

When application user interface 301 and context indicator 306 are displayed as shown in FIG. 3A, the user can tap context indicator 306. In response to tapping context indicator 306, a floating command bar 307 is invoked and displayed adjacent to the selected word 305, as shown in FIG. 3C. In this implementation, the set of commands provided by floating command bar 307 includes only: a cut command, a copy command, and paste command that are implemented by corresponding buttons. It can be appreciated that floating command bar 307 allows the user to execute a set of most frequently-used commands, a key at the upper-right of virtual keyboard 303 allows the user to execute a delete command, and options in ribbon 304 allow the user to execute formatting commands. As such, various important commands that are relevant to the context are made easily accessible to the user.

As shown in FIG. 3D, in response to placing an insertion pointer 308 after a word in document 302, context indicator 306 is presented to the lower-right of insertion pointer 308. In response to the user tapping the touchscreen user interface, insertion pointer 306 is placed at a position corresponding to the user's touch point which invokes display of context indicator 306. If the user interacts with virtual keyboard 303 to add document content, context indicator 306 will be dismissed.

In some scenarios, when the user taps the touchscreen user interface to place insertion pointer 308 or to make a selection, context indicator 306 would not be visible (e.g., occluded by virtual keyboard 303, positioned off-screen, etc.) if positioned to the lower-right of insertion pointer 308. As one exemplary fallback position, context indicator 306 can be invoked and displayed to the upper-right of insertion pointer 308. As another exemplary fallback position, the context indicator can be invoked and displayed to the upper-left of the insertion pointer 308.

When application user interface 301 and context indicator 306 are displayed as shown in FIG. 3D, the user can tap context indicator 306. In response to tapping context indicator 306, floating command bar 307 is invoked and displayed extending to the right, as shown in FIG. 3E. In this implementation, the set of commands provided by floating command bar 307 includes only: a cut command, a copy command, and a paste command that are implemented by corresponding buttons. Within floating command bar 307, the cut command button and the copy command button can be faded to indicate that the cut command and the copy command are currently unavailable for the given context. It can be appreciated that floating command bar 307 can include a common set of commands across multiple contexts.

In some scenarios, when the user taps the touchscreen user interface to select context 306 indicator, floating command bar 307 would not be visible (e.g., occluded by virtual keyboard 303, positioned off-screen, etc.) if extended to the right. In such scenarios, floating command bar 307 can be invoked at various fallback positions and/or extended in other directions so that floating command bar 307 is visible on the touchscreen user interface. In one exemplary scenario, floating command bar 307 can be invoked at a fallback position and extended to the left and to the right.

Referring to FIG. 3F, context indicator 306 can be invoked in response to the user's selection of text and can be displayed to the lower-right of the selected text. The user can tap the touchscreen user interface to select context indicator 306. In response to the user's selection of context indicator 306, floating command bar 307 replaces context indicator 306 extending to the right, as shown in FIG. 3G. Floating command 307 bar can provide an exemplary set of commands including: a clipboard command, a comment command, and a proofing command that are implemented by corresponding buttons.

The user can tap a parent command 308 (e.g., the clipboard command button) in floating command bar 307 to invoke a submenu 309 implemented as a radial clipboard control that is displayed over floating command bar 307, as shown in FIG. 3H. Submenu 309 can include an exemplary set of submenu (e.g., clipboard) commands including: cut, copy, delete, and paste that are implemented by corresponding buttons. The user can execute a particular submenu command by tapping a corresponding command button of submenu 309.

In addition, when application user interface 301 and floating command bar 307 are displayed as shown in FIG. 3G, the user can execute a particular submenu command (e.g., copy) directly from floating command bar 307 by swiping parent command 308 (e.g., clipboard command button) in a direction (e.g., up) that corresponds to the positioning of the particular submenu command in underlying submenu 309 (shown in FIG. 3H). In response the user swiping parent command button 308, an indication of the particular executed command can be displayed momentarily and then dismissed.

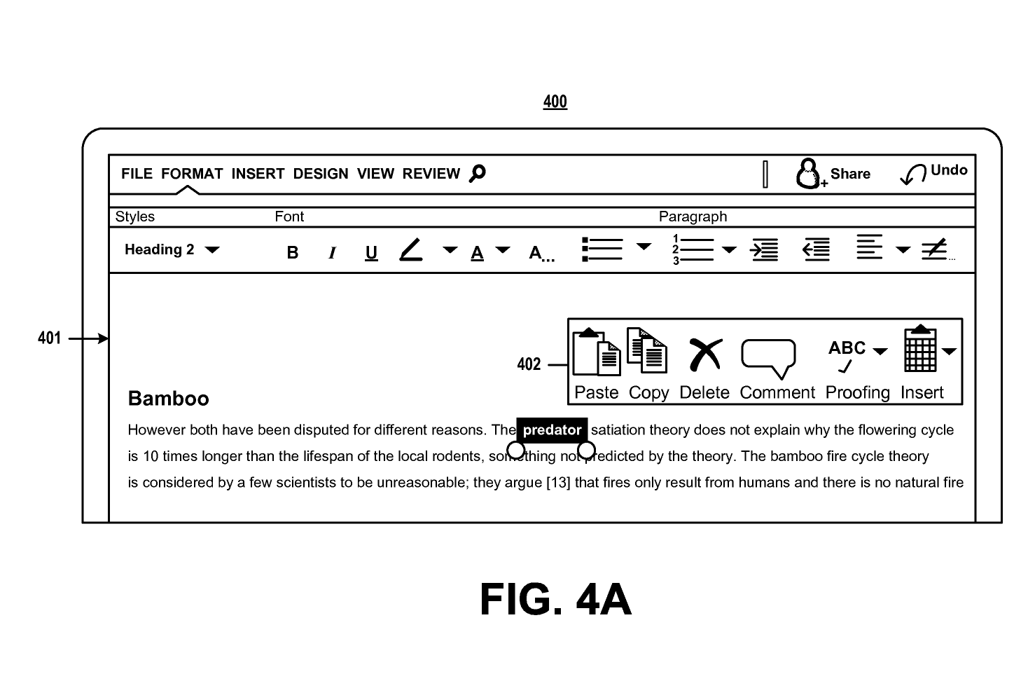

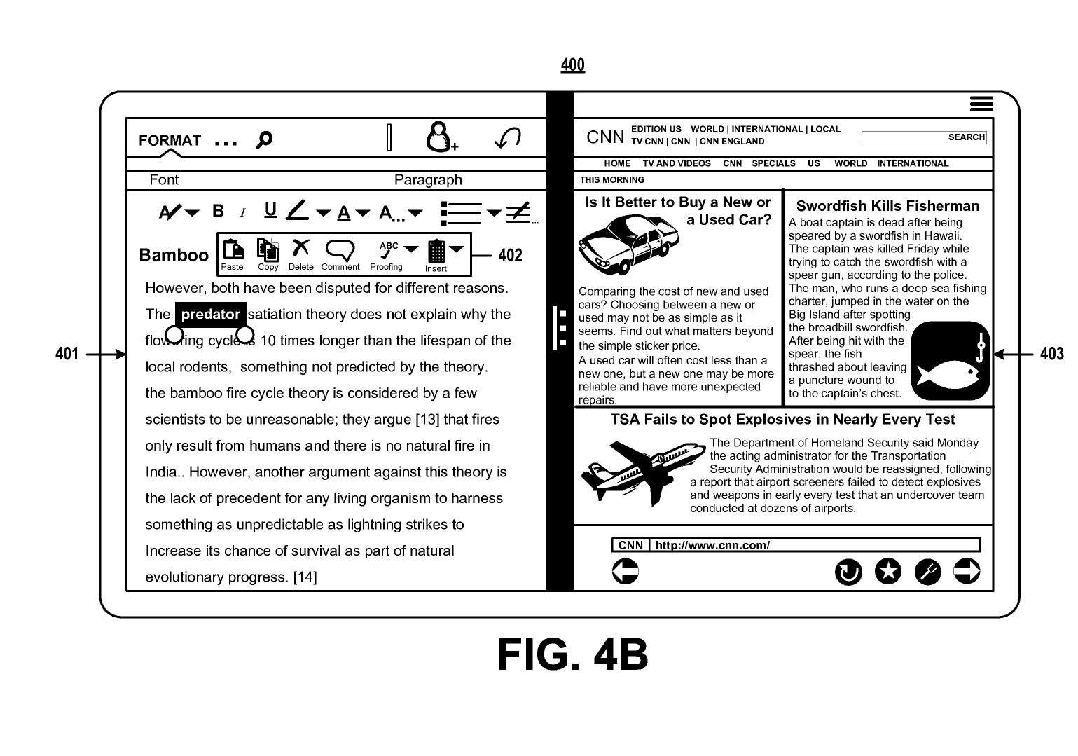

FIGS. 4A and 4B illustrate exemplary context menu implementations on a touchscreen computing device 400. As shown in FIG. 1A, touchscreen computing device 400 presents and application user interface 401 (e.g., word processing application user interface) that displays a floating command bar 402 to the upper-right of selected text. Floating command bar 402 is entirely visible in portrait view. In this implementation, the set of commands provided by floating command bar 402 includes: a paste command, a copy command, a delete command, a comment command, a proofing command, and an insert table command that are implemented by corresponding buttons. The proofing command button and the insert table button can invoke corresponding submenus. When the orientation of touchscreen computing device 400 is switched from vertical to horizontal and an additional application user interface 403 (e.g., web browser application user interface) is displayed, floating command bar 402 is displayed to the upper-right of selected text in application user interface 401 and is still entirely visible in 50/50 landscape view, as shown in FIG. 4B.

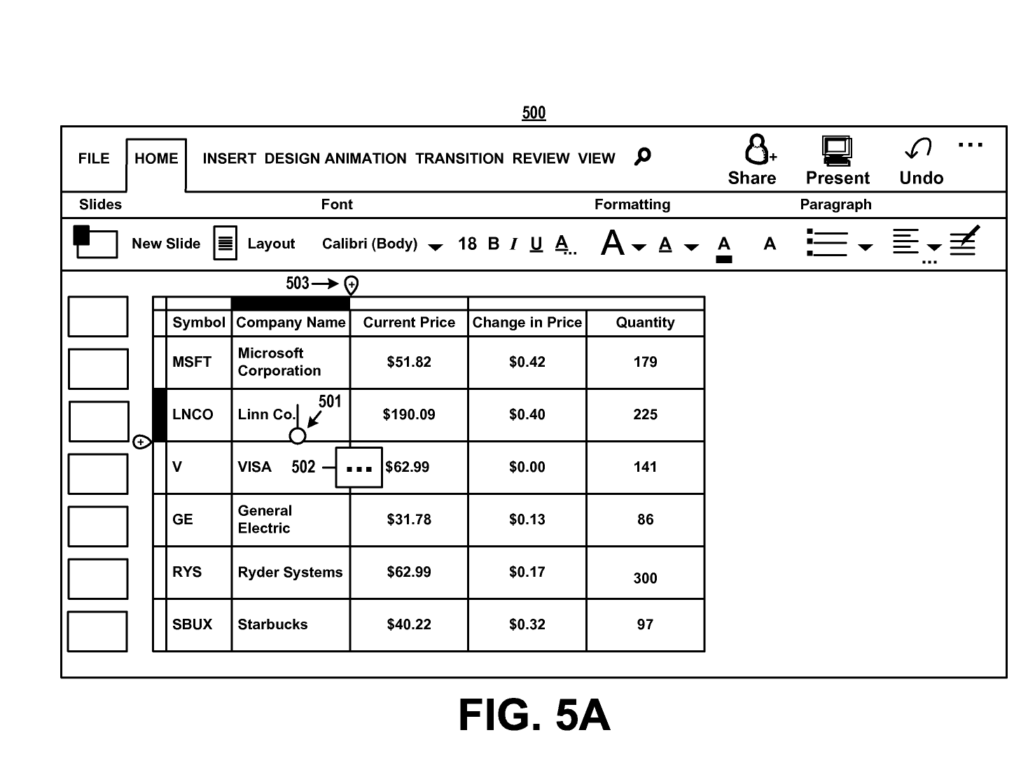

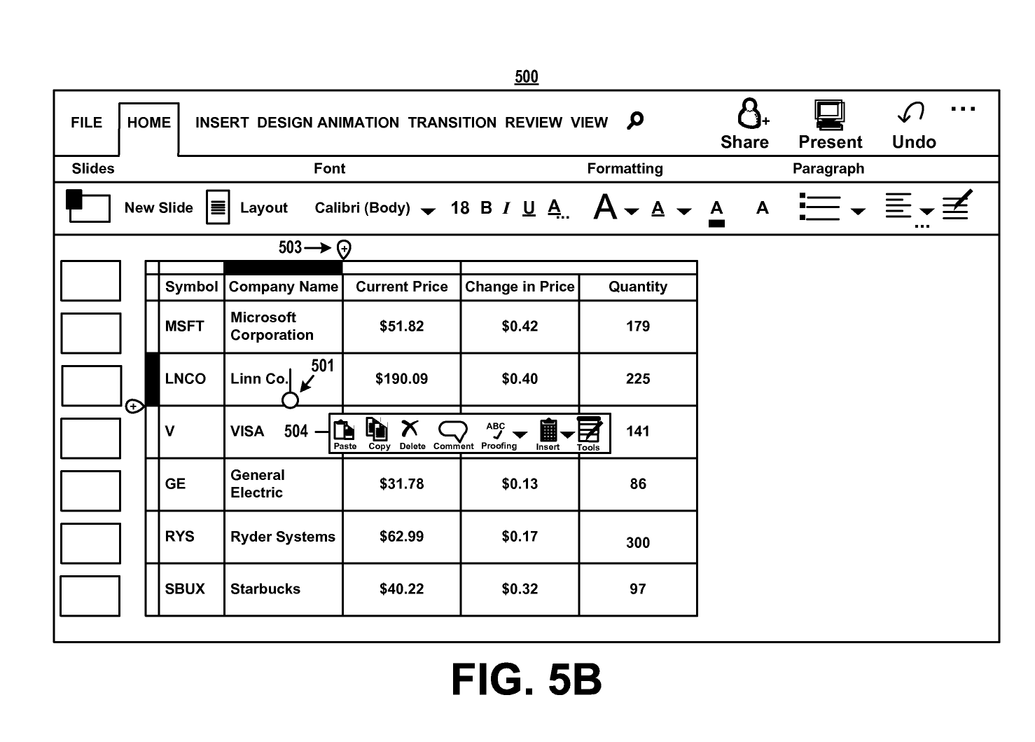

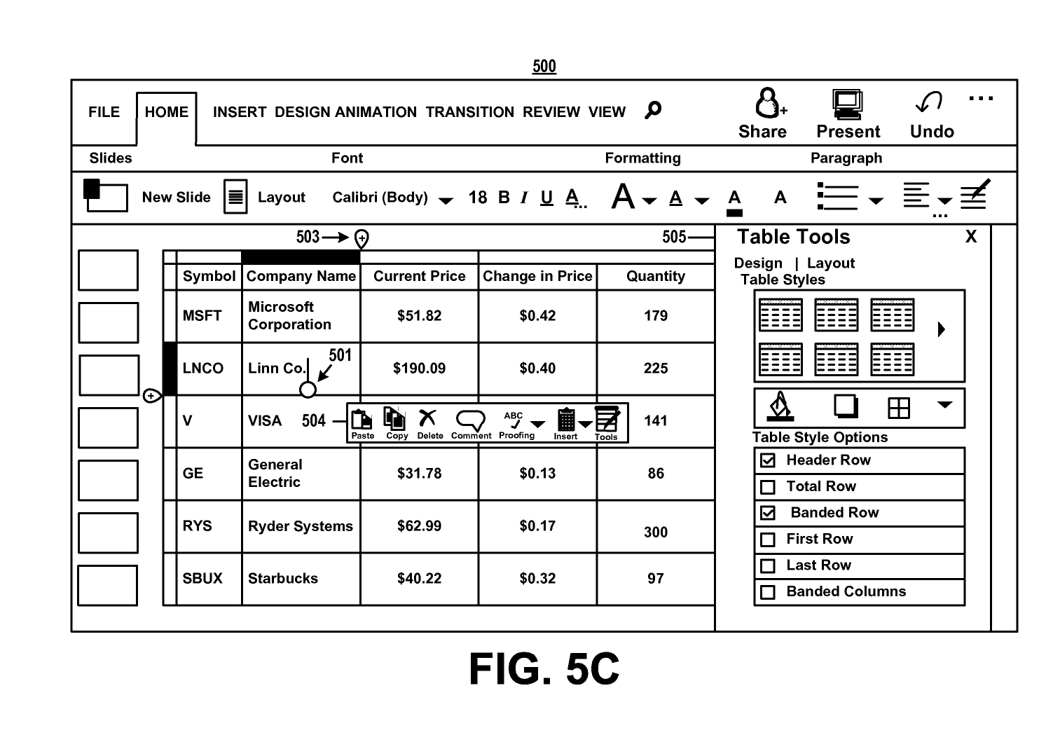

FIGS. 5A-C illustrate exemplary context menu implementations for an application user interface 500 executing on a touchscreen computing device. As shown in FIG. 5A, a user can touch a table displayed by a slideshow presentation application slide and, in response, an insertion pointer 501 is placed after text within a cell, and a context indicator 502 is presented to the lower-right of the cell. In addition, a specialized control 503 (e.g., an insert row/column widget) is displayed along with context indicator 502.

In response to tapping context indicator 502, a floating command bar 504 is invoked and displayed to the lower-right of insertion pointer 501, as shown in FIG. 5B. A set of exemplary commands provided by floating command bar 504 include: a past command, a copy command, a delete command, a comment command, a proofing command (parent command that opens a submenu), an insert command (parent command that opens a submenu), and a tools command. In response to tapping the tools command button, a fixed contextual tab/pane 505 is launched to allow more involved contextual interactions, as shown in FIG. 5C. As such, various important commands that are relevant to the context are made easily accessible to the user.

A context menu can be implemented for other types of applications. For example, in response to selecting a cell in a spreadsheet application document, a context indicator can be presented to the lower-right of a selected cell. In response to tapping the context indicator, a floating command bar can be invoked and displayed adjacent to the selected cell. A set of exemplary commands provided by the floating command bar can include: a past command, a cut command, a copy command, and a clear contents command that are implemented by corresponding buttons. Within the floating command bar, the paste command button can be faded to indicate that the paste command is currently unavailable for the given context.

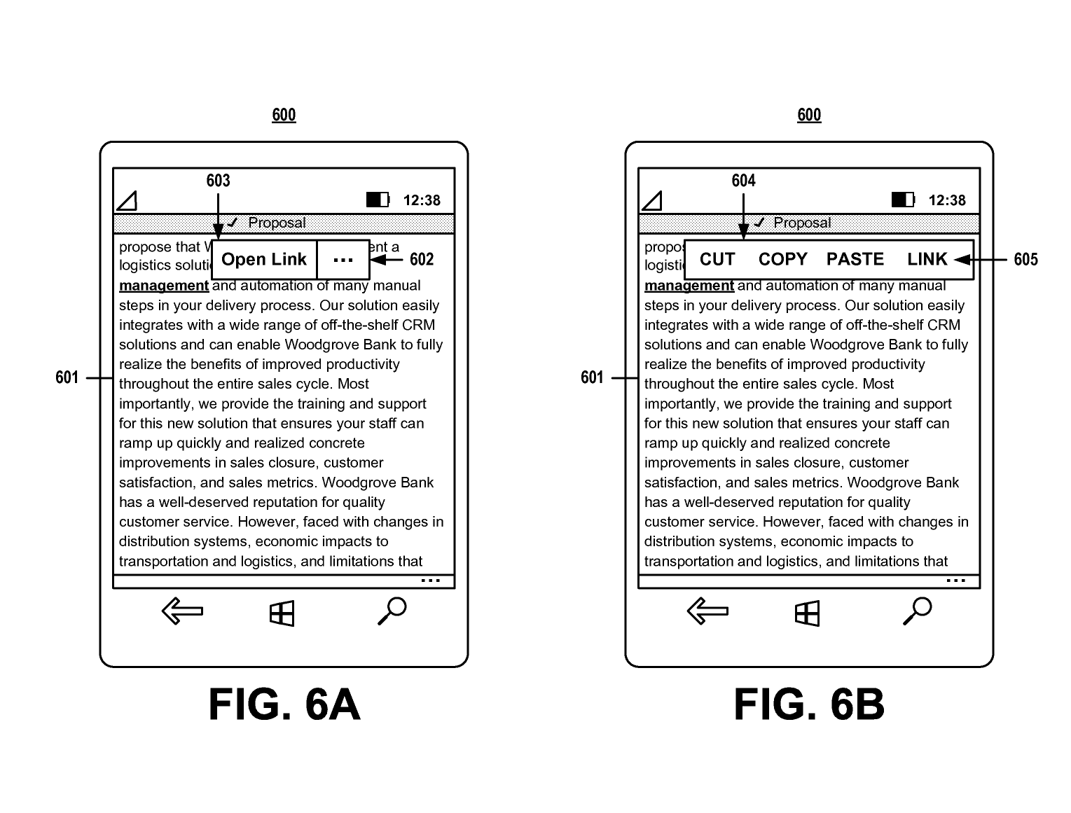

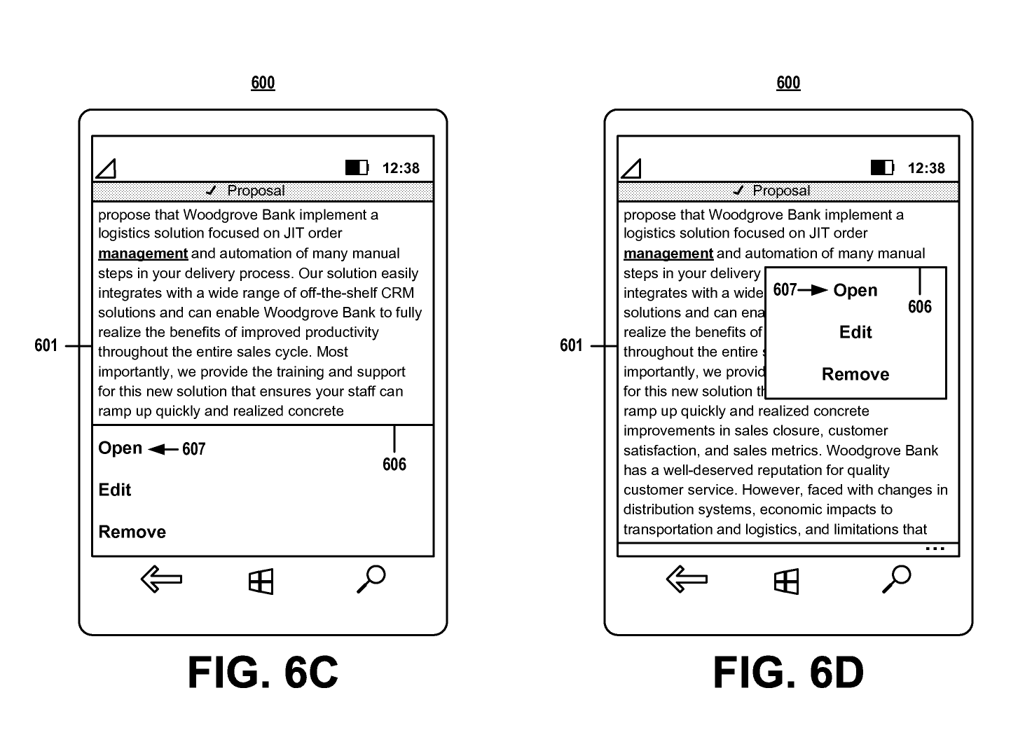

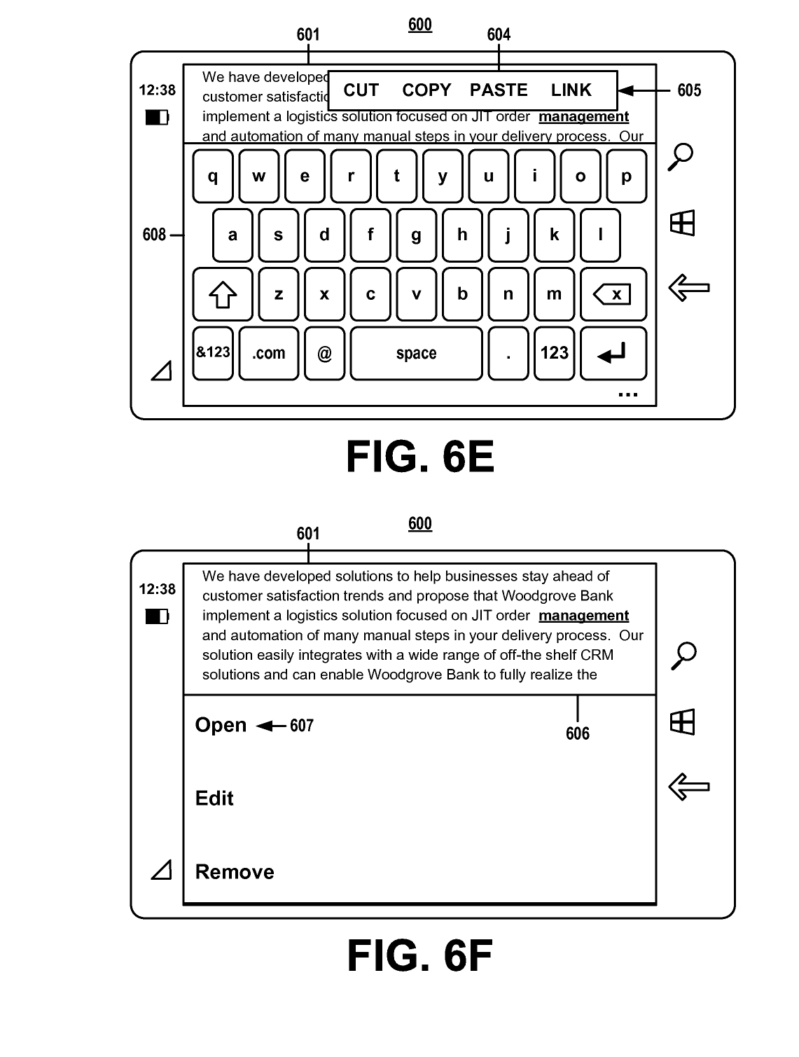

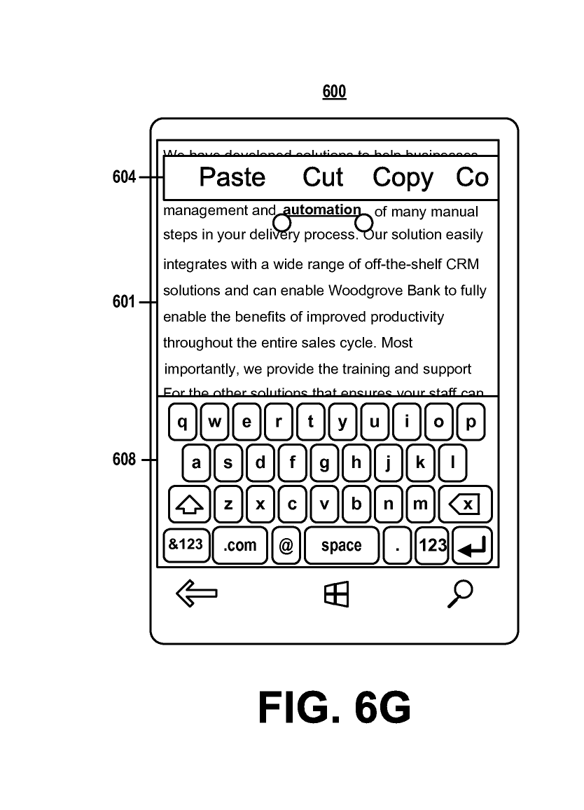

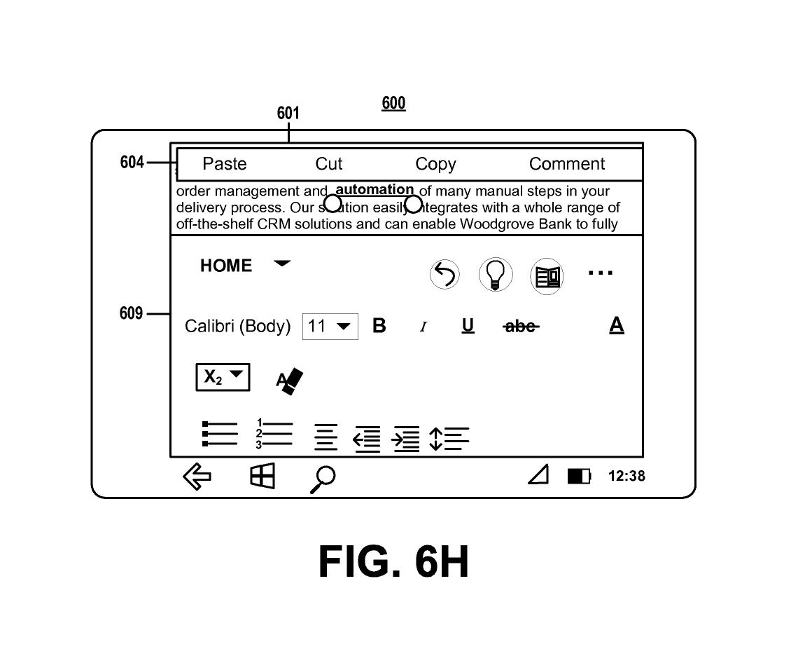

FIGS. 6A-H illustrate exemplary context menu implementations on a touchscreen mobile computing device 600. As shown in FIG. 6A, touchscreen mobile computing device 600 presents an application user interface 601 that displays a context indicator 602 appended to a single selectable command button 603. Context indicator 602 is configured to invoke a floating command bar 604, as shown in FIG. 6B. Floating command bar 604 employs buttons having words not icons and is entirely visible on the touchscreen user interface in portrait view. Floating command bar 604 includes a parent command button 605 (e.g., link command button) that is configured to open a submenu.

In one implementation, upon selection of parent command button 605 (e.g., link command button) shown in FIG. 6B, floating command bar 604 is hidden or dismissed and a submenu 606 is anchored to the bottom of the user interface, as shown in FIG. 6C. In another implementation, upon selection of parent command button 605, floating command bar 604 is hidden or dismissed and submenu 606 is displayed as a floating menu, as shown in FIG. 6D. Submenu 606 includes submenu commands including submenu command 607 (e.g., open command) associated with parent command button 605.

With reference to FIGS. 6A-D, selectable command button 603 can be configured to invoke a predicted command corresponding to a contextual command of floating menu bar 604 or a submenu command of submenu 606. For example, the predicted command can be the most-frequently used command of floating menu bar 604 or submenu 606. In one exemplary implementation, selectable command button 603 is configured to open a link, which corresponds to submenu command 607. The selection of linked text can be a scenario or context in which it is highly likely that the user intends to (or will choose to) open a link. Rather than bypassing context indicator 602 and automatically expanding floating command bar 604 and submenu 606, context indicator 602 is presented in conjunction with selectable button 603 that is configured to execute the predicted or highly probable action.

A paste (after copy) button is another example of selectable command button 603 that can be displayed together with context indicator 602. A paste recovery button is another example of selectable command button 603 that can be displayed together with context indicator 602. The paste recovery button can be a parent command button that is configured to open a submenu. In proofing scenarios, context indicator 602 can be presented with selectable command button 603 that displays a suggested word in response to selection of (or insertion pointer placement after) a marked (misspelled or unrecognized) word. In some scenarios, context indicator 602 can be presented in conjunction with multiple commands implemented as a multi-function button or implemented as separate buttons. For example, context indicator 602 can be presented in conjunction with accept/reject commands in scenarios in which the user can review changes or merge conflicts.

As shown in FIG. 6E, floating command bar 604 and a virtual keyboard 608 are displayed in landscape view. In one implementation, upon selection of parent command button 605 (e.g., link command button) of floating command bar 604, floating command bar 604 and virtual keyboard 608 are hidden or dismissed together and submenu 606 is displayed and anchored to the bottom of the user interface, as shown in FIG. 6F. In another implementation, upon selection of parent command button 605, floating command bar 604 and virtual keyboard 608 are hidden or dismissed together and submenu 606 is displayed as a floating menu. Dismissal of virtual keyboard 608 can be based on a determination or prediction that virtual keyboard 608 will not be needed at the submenu level.

As shown in FIG. 6G, in some implementations, floating command bar 604 can be presented above selected text but not be fully visible in portrait view. Floating command bar can be presented in conjunction with virtual keyboard 608. Floating command bar 604 can be horizontally pannable so that, when switched to landscape view, the full floating command bar 604 can be displayed, as shown in FIG. 6H. In addition, virtual keyboard 608 can be replaced with a toolbar 609 when horizontally panned.

### Exemplary Process for Providing a Context Menu

With continuing reference to the foregoing figures, an exemplary process is described below to further illustrate aspects of the described subject matter. It is to be understood that the following exemplary process is not intended to limit the described subject matter to particular implementations.

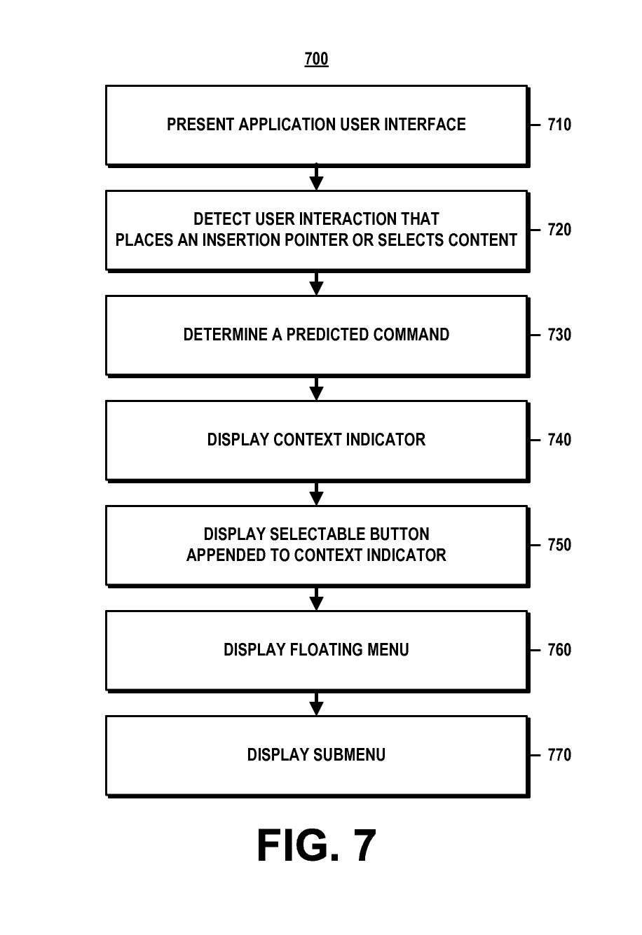

FIG. 7 illustrates a computer-implemented method 700 as an embodiment of an exemplary process for command surface drill-in control in accordance with aspects of the described subject matter. In various embodiments, computer-implemented method 700 can be performed by a computing device and/or a computer system including one or more computing devices. It is to be appreciated that computer-implemented method 700, or portions thereof, can be performed by various computing devices, computer systems, components, and/or computer-executable instructions stored on one more computer-readable storage media.

At 710, a computing device can present an application user interface. For example, a computing device (e.g., client devices 101-106, touchscreen computing device 300, touchscreen computing device 400, touchscreen mobile computing device 600, etc.) can present an application user interface (e.g., application user interface 200, application user interface 301, application user interface 401, application user interface 500, application user interface 601, etc.) for display to a user. It is to be understood and appreciated that an application user interface can be implemented by various applications including, but not limited to: word processing applications, spreadsheet applications, slideshow presentation applications, note taking applications, email applications, text messaging applications, and other types of applications that enable users to select, author, and/or edit content.

At 720, the computing device can detect user interaction that places an insertion pointer or selects content. For example, the computing device can detect user interactions such as tapping a touch screen to place an insertion pointer, double tapping to select a word or object, placing and dragging and insertion pointer to select a block of text or other content, executing a press-and-hold command to select object (e.g., image), and so forth. It is to be understood and appreciated that various types of user interactions and/or input devices can be employed to place an insertion pointer or select content.

At 730, the computing device can determine a predicted command. For example, a predicted command can be determined based on the user interaction (e.g., placement of an insertion pointer after a marked and misspelled word, selection of linked text, etc.) and/or a prior command that was executed (e.g., paste after copy, etc.). The predicted command can correspond to a contextual command of a floating menu (e.g., floating command bar 205, floating command bar 307, floating command bar 402, floating command bar 504, floating command bar 605, etc.) or a submenu command of a submenu (e.g., submenu 207, submenu 309, submenu 606, etc.). The predicted command can be determined based on: a contextual command of the floating menu that is most-frequently used by a community of users, a contextual command of the floating menu that is most-frequently used by a user of the computing device, a submenu command of a submenu that is most-frequently used by the community of users, and/or a submenu command of the submenu that is most-frequently used by the user of the computing device.

At 740, the computing device can display a context indicator. For example, a context indicator (e.g., context indicator 204, context indicator 306, context indicator 502, context indicator 602, etc.) that is configured to invoke an underlying floating menu can be displayed in response to user interaction that places an insertion pointer or selects content in an application user interface. The context indicator can be implemented as a single selectable object (e.g., a button that displays a graphic, icon, character, etc.) that is positioned near the insertion pointer or selection and that is used to indicate the existence of an underlying floating menu having contextual commands. Selection of the context indicator can invoke the underlying floating menu (e.g., floating command bar 205, floating command bar 307, floating command bar 402, floating command bar 504, floating command bar 605, etc.) and hide or dismiss the context indicator.

At 750, the computing device can display a selectable button appended to the context indicator. For example, a selectable button such as selectable button 603 can be appended to context indicator 602. It is also to be understood and appreciated that a selectable button can be appended to any of context indicator 204, context indicator 306, context indicator 502, or other type of context indicator that is configured to invoke an underlying floating menu. The selectable button is configured to invoke the predicted command that corresponds to a contextual command of the floating menu (e.g., floating command bar 205, floating command bar 307, floating command bar 402, floating command bar 504, floating command bar 605, etc.) or a submenu command of the submenu (e.g., submenu 207, submenu 309, submenu 606, etc.).

At 760, the computing device can display a floating menu. For example, a floating menu (e.g., floating command bar 205, floating command bar 307, floating command bar 402, floating command bar 504, floating command bar 605) can be displayed in response to selection of a context indicator. The floating menu can hide or dismiss the context indictor and present the user with a set of contextual commands relevant to the user interaction. The set of contextual commands can include a parent command (e.g., proofing command, wrap text command, clipboard command, insert command, link command, paste recovery command, etc.) that is configured to invoke a submenu. In scenarios where there is a high confidence of intended user action, display of the context indicator can be bypassed, and the floating menu can be automatically invoked in response to insertion pointer placement or content selection.

At 770, the computing device can display a submenu. For example, a submenu (e.g., submenu 207, submenu 309, submenu 606, etc.) can be displayed in response to selection of a parent command of the floating command bar (e.g., floating command bar 205, floating command bar 307, floating command bar 402, floating command bar 504, floating command bar 605, etc.). The submenu can be displayed with the floating menu and present submenu commands associated with the parent command. When the floating menu and the submenu are displayed together, touch input that is outside of both the floating menu and the submenu can dismiss the floating menu and the submenu together. In some implementations, display of the submenu can dismiss the floating menu.

### Exemplary Operating Environments

Aspects of the described subject matter can be implemented for and/or by various operating environments, computer networks, platforms, frameworks, computer architectures, and/or computing devices. Aspects of the described subject matter can be implemented by computer-executable instructions that can be executed by one or more computing devices, computer systems, and/or processors.

In its most basic configuration, a computing device and/or computer system can include at least one processing unit (e.g., single-processor units, multi-processor units, single-core units, and/or multi-core units) and memory. Depending on the exact configuration and type of computer system or computing device, the memory implemented by a computing device and/or computer system can be volatile (e.g., random access memory (RAM)), non-volatile (e.g., read-only memory (ROM), flash memory, and the like), or a combination thereof.

A computing device and/or computer system can have additional features and/or functionality. For example, a computing device and/or computer system can include hardware such as additional storage (e.g., removable and/or non-removable) including, but not limited to: solid state, magnetic, optical disk, or tape.

A computing device and/or computer system typically can include or can access a variety of computer-readable media. For instance, computer-readable media can embody computer-executable instructions for execution by a computing device and/or a computer system. Computer readable media can be any available media that can be accessed by a computing device and/or a computer system and includes both volatile and non-volatile media, and removable and non-removable media. As used herein, the term “computer-readable media” includes computer-readable storage media and communication media.

The term “computer-readable storage media” as used herein includes volatile and nonvolatile, removable and non-removable media for storage of information such as computer-executable instructions, data structures, program modules, or other data. Examples of computer-readable storage media include, but are not limited to: memory storage devices such as RAM, ROM, electrically erasable program read-only memory (EEPROM), semiconductor memories, dynamic memory (e.g., dynamic random access memory (DRAM), synchronous dynamic random access memory (SDRAM), double data rate synchronous dynamic random-access memory (DDR SDRAM), etc.), integrated circuits, solid-state drives, flash memory (e.g., NAN-based flash memory), memory chips, memory cards, memory sticks, thumb drives, and the like; optical storage media such as Blu-ray discs, digital video discs (DVDs), compact discs (CDs), CD-ROM, optical disc cartridges, and the like; magnetic storage media including hard disk drives, floppy disks, flexible disks, magnetic cassettes, magnetic tape, and the like; and other types of computer-readable storage devices. It can be appreciated that various types of computer-readable storage media (e.g., memory and additional hardware storage) can be part of a computing device and/or a computer system. As used herein, the terms “computer-readable storage media” and “computer-readable storage medium” do not mean and unequivocally exclude a propagated signal, a modulated data signal, a carrier wave, or any other type of transitory computer-readable medium.

Communication media typically embodies computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

In various embodiments, aspects the described subject matter can be implemented by computer-executable instructions stored on one or more computer-readable storage media. Computer-executable instructions can be implemented using any various types of suitable programming and/or markup languages such as: Extensible Application Markup Language (XAML), XML, XBL HTML, XHTML, XSLT, XMLHttpRequestObject, CSS, Document Object Model (DOM), Java®, JavaScript, JavaScript Object Notation (JSON), Jscript, ECMAScript, Ajax, Flash®, Silverlight™, Visual Basic® (VB), VBScript, PHP, ASP, Shockwave®, Python, Perl®, C, Objective-C, C++, C#/.net, and/or others.

A computing device and/or computer system can include various input devices, output devices, communication interfaces, and/or other types of devices. Exemplary input devices include, without limitation: a user interface, a keyboard/keypad, a touch screen, a touch pad, a pen, a mouse, a trackball, a remote control, a game controller, a camera, a barcode reader, a microphone or other voice input device, a video input device, laser range finder, a motion sensing device, a gesture detection device, and/or other type of input mechanism and/or device. A computing device can provide a Natural User Interface (NUI) that enables a user to interact with the computing device in a “natural” manner, free from artificial constraints imposed by input devices such as mice, keyboards, remote controls, and the like. Examples of NUI technologies include, without limitation: voice and/or speech recognition, touch and/or stylus recognition, motion and/or gesture recognition both on screen and adjacent to a screen using accelerometers, gyroscopes and/or depth cameras (e.g., stereoscopic or time-of-flight camera systems, infrared camera systems, RGB camera systems and/or combination thereof), head and eye tracking, gaze tracking, facial recognition, 3D displays, immersive augmented reality and virtual reality systems, technologies for sensing brain activity using electric field sensing electrodes (EEG and related methods), intention and/or goal understanding, and machine intelligence.

A computing device can be configured to receive and respond to input in various ways depending upon implementation. Responses can be presented in various forms including, for example: presenting a user interface, outputting an object such as an image, a video, a multimedia object, a document, and/or other type of object; outputting a text response; providing a link associated with responsive content; outputting a computer-generated voice response or other audio; or other type of visual and/or audio presentation of a response. Exemplary output devices include, without limitation: a display, a projector, a speaker, a printer, and/or other type of output mechanism and/or device.

A computing device and/or computer system can include one or more communication interfaces that allow communication between and among other computing devices and/or computer systems. Communication interfaces can be used in the context of network communication between and among various computing devices and/or computer systems. Communication interfaces can allow a computing device and/or computer system to communicate with other devices, other computer systems, web services (e.g., an affiliated web service, a third-party web service, a remote web service, and the like), web service applications, and/or information sources (e.g. an affiliated information source, a third-party information source, a remote information source, and the like). As such communication interfaces can be used in the context of accessing, obtaining data from, and/or cooperating with various types of resources.

Communication interfaces also can be used in the context of distributing computer-executable instructions over a network or combination of networks. For example, computer-executable instructions can be combined or distributed utilizing remote computers and storage devices. A local or terminal computer can access a remote computer or remote storage device and download a computer program or one or more parts of the computer program for execution. It also can be appreciated that the execution of computer-executable instructions can be distributed by executing some instructions at a local terminal and executing some instructions at a remote computer.

A computing device can be implemented by a mobile computing device such as: a mobile phone (e.g., a cellular phone, a smart phone such as a Microsoft® Windows® phone, an Apple iPhone, a BlackBerry® phone, a phone implementing a Google® Android™ operating system, a phone implementing a Linux® operating system, or other type of phone implementing a mobile operating system), a tablet computer (e.g., a Microsoft® Surface® device, an Apple iPad™, a Samsung Galaxy Note® Pro, or other type of tablet device), a laptop computer, a notebook computer, a netbook computer, a personal digital assistant (PDA), a portable media player, a handheld gaming console, a wearable computing device (e.g., a smart watch, a head-mounted device including smart glasses such as Google® Glass™, a wearable monitor, etc.), a personal navigation device, a vehicle computer (e.g., an on-board navigation system), a camera, or other type of mobile device.

A computing device can be implemented by a stationary computing device such as: a desktop computer, a personal computer, a server computer, an entertainment system device, a media player, a media system or console, a video-game system or console, a multipurpose system or console (e.g., a combined multimedia and video-game system or console such as a Microsoft® Xbox® system or console, a Sony® PlayStation® system or console, a Nintendo® system or console, or other type of multipurpose game system or console), a set-top box, an appliance (e.g., a television, a refrigerator, a cooking appliance, etc.), or other type of stationary computing device.

A computing device also can be implemented by other types of processor-based computing devices including digital signal processors, field-programmable gate arrays (FPGAs), program- and application-specific integrated circuits (PASIC/ASICs), program- and application-specific standard products (PSSP/ASSPs), a system-on-a-chip (SoC), complex programmable logic devices (CPLDs), and the like.

A computing device can include and/or run one or more computer programs implemented, for example, by software, firmware, hardware, logic, and/or circuitry of the computing device. Computer programs can be distributed to and/or installed on a computing device in various ways. For instance, computer programs can be pre-installed on a computing device by an original equipment manufacturer (OEM), installed on a computing device as part of installation of another computer program, downloaded from an application store and installed on a computing device, distributed and/or installed by a system administrator using an enterprise network management tool, and distributed and/or installed in various other ways depending upon the implementation.

Computer programs implemented by a computing device can include one or more operating systems. Exemplary operating systems include, without limitation: a Microsoft® operating system (e.g., a Microsoft® Windows ® operating system), a Google® operating system (e.g., a Google® Chrome OS™ operating system or a Google® Android™ operating system), an Apple operating system (e.g., a Mac OS® or an Apple iOS™ operating system), an open source operating system, or any other operating system suitable for running on a mobile, stationary, and/or processor-based computing device.

Computer programs implemented by a computing device can include one or more client applications. Exemplary client applications include, without limitation: a web browsing application, a communication application (e.g., a telephony application, an e-mail application, a text messaging application, an instant messaging application, a web conferencing application, and the like), a media application (e.g., a video application, a movie service application, a television service application, a music service application, an e-book application, a photo application, and the like), a calendar application, a file sharing application, a personal assistant or other type of conversational application, a game application, a graphics application, a shopping application, a payment application, a social media application, a social networking application, a news application, a sports application, a weather application, a mapping application, a navigation application, a travel application, a restaurants application, an entertainment application, a healthcare application, a lifestyle application, a reference application, a finance application, a business application, an education application, a productivity application (e.g., word processing application, a spreadsheet application, a slide show presentation application, a note-taking application, and the like), a security application, a tools application, a utility application, and/or any other type of application, application program, and/or app suitable for running on a mobile, stationary, and/or processor-based computing device.

Computer programs implemented by a computing device can include one or more server applications. Exemplary server applications include, without limitation: one or more server-hosted, cloud-based, and/or online applications associated with any of the various types of exemplary client applications described above; one or more server-hosted, cloud-based, and/or online versions of any of the various types of exemplary client applications described above; one or more applications configured to provide a web service, a web site, a web page, web content, and the like; one or more applications configured to provide and/or access an information source, data store, database, repository, and the like; and/or other type of application, application program, and/or app suitable for running on a server computer.

A computer system can be implemented by a computing device, such as a server computer, or by multiple computing devices configured to implement a service in which one or more suitably-configured computing devices perform one or more processing steps. A computer system can be implemented as a distributed computing system in which components are located on different computing devices that are connected to each other through network (e.g., wired and/or wireless) and/or other forms of direct and/or indirect connections. A computer system also can be implemented via a cloud-based architecture (e.g., public, private, or a combination thereof) in which services are delivered through shared datacenters. For instance, a computer system can be implemented by physical servers of a datacenter that provide shared computing and storage resources and that host virtual machines having various roles for performing different tasks in conjunction with providing cloud-based services. Exemplary virtual machine roles can include, without limitation: web server, front end server, application server, database server (e.g., SQL server), domain controller, domain name server, directory server, and/or other suitable machine roles. Some components of a computer system can be disposed within a cloud while other components are disposed outside of the cloud.

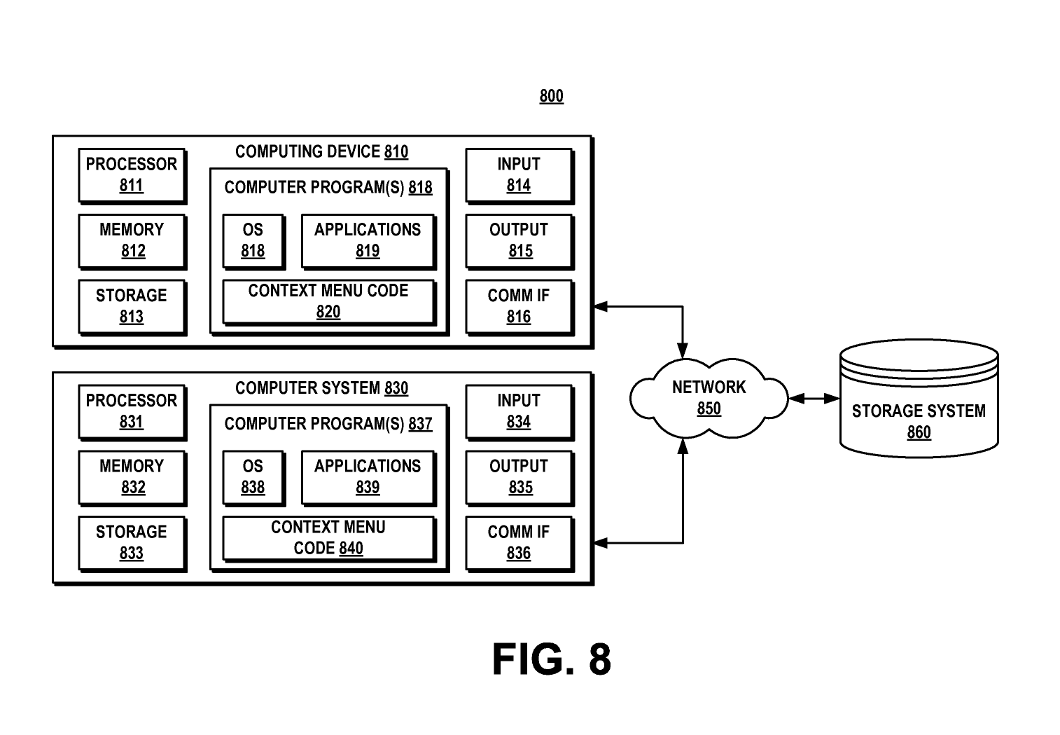

FIG. 8 illustrates an operating environment 800 as an embodiment of an exemplary operating environment that can implement aspects of the described subject matter. It is to be appreciated that operating environment 800 can be implemented by a client-server model and/or architecture as well as by other operating environment models and/or architectures in various embodiments.

Operating environment 800 includes a computing device 810, which can implement aspects of the described subject matter. Computing device 810 includes a processor 811 and memory 812. Computing device 810 also includes additional hardware storage 813. It is to be understood that computer-readable storage media includes memory 812 and hardware storage 813.

Computing device 810 includes input devices 814 and output devices 815. Input devices 814 can include one or more of the exemplary input devices described above and/or other type of input mechanism and/or device. Output devices 815 can include one or more of the exemplary output devices described above and/or other type of output mechanism and/or device.

Computing device 810 contains one or more communication interfaces 816 that allow computing device 810 to communicate with other computing devices and/or computer systems. Communication interfaces 816 also can be used in the context of distributing computer-executable instructions.

Computing device 810 can include and/or run one or more computer programs 817 implemented, for example, by software, firmware, hardware, logic, and/or circuitry of computing device 810. Computer programs 817 can include an operating system 818 implemented, for example, by one or more exemplary operating systems described above and/or other type of operating system suitable for running on computing device 810. Computer programs 817 can include one or more applications 819 implemented, for example, by one or more exemplary applications described above and/or other type of application suitable for running on computing device 810.

Computer programs 817 can be configured via one or more suitable interfaces (e.g., API or other data connection) to communicate and/or cooperate with one or more resources. Examples of resources include local computing resources of computing device 810 and/or remote computing resources such as server-hosted resources, cloud-based resources, online resources, remote data stores, remote databases, remote repositories, web services, web sites, web pages, web content, and/or other types of remote resources.

Computer programs 817 can implement computer-executable instructions that are stored in computer-readable storage media such as memory 812 or hardware storage 813, for example. Computer-executable instructions implemented by computer programs 817 can be configured to work in conjunction with, support, and/or enhance one or more of operating system 818 and applications 819. Computer-executable instructions implemented by computer programs 817 also can be configured to provide one or more separate and/or stand-alone services.

Computing device 810 and/or computer programs 817 can implement and/or perform various aspects of the described subject matter. As shown, computing device 810 and/or computer programs 817 can include context menu code 820. In various embodiments, context menu code 820 can include computer-executable instructions that are stored on a computer-readable storage medium and configured to implement one or more aspects of the described subject matter. By way of example, and without limitation, context menu code 820 can be implemented by computing device 810 which, in turn, can represent any one of client devices 101-106, touchscreen computing device 300, touchscreen computing device 400, or touchscreen mobile computing device 600. By way of further example, and without limitation, context menu code 820 can implement context menu module 110, implement a context menu for an application user interface, and/or perform one or more aspects of computer-implemented method 700.

Operating environment 800 includes a computer system 830, which can implement aspects of the described subject matter. Computer system 830 can be implemented by one or more computing devices such as one or more server computers. Computer system 830 includes a processor 831 and memory 832. Computer system 830 also includes additional hardware storage 833. It is to be understood that computer-readable storage media includes memory 832 and hardware storage 833.

Computer system 830 includes input devices 834 and output devices 835. Input devices 834 can include one or more of the exemplary input devices described above and/or other type of input mechanism and/or device. Output devices 835 can include one or more of the exemplary output devices described above and/or other type of output mechanism and/or device.

Computer system 830 contains one or more communication interfaces 836 that allow computer system 830 to communicate with various computing devices (e.g., computing device 810) and/or other computer systems. Communication interfaces 836 also can be used in the context of distributing computer-executable instructions.

Computer system 830 can include and/or run one or more computer programs 837 implemented, for example, by software, firmware, hardware, logic, and/or circuitry of computer system 830. Computer programs 837 can include an operating system 838 implemented, for example, by one or more exemplary operating systems described above and/or other type of operating system suitable for running on computer system 830. Computer programs 837 can include one or more applications 839 implemented, for example, by one or more exemplary applications described above and/or other type of application suitable for running on computer system 830.

Computer programs 837 can be configured via one or more suitable interfaces (e.g., API or other data connection) to communicate and/or cooperate with one or more resources. Examples of resources include local computing resources of computer system 830 and/or remote computing resources such as server-hosted resources, cloud-based resources, online resources, remote data stores, remote databases, remote repositories, web services, web sites, web pages, web content, and/or other types of remote resources.

Computer programs 837 can implement computer-executable instructions that are stored in computer-readable storage media such as memory 832 or hardware storage 833, for example. Computer-executable instructions implemented by computer programs 837 can be configured to work in conjunction with, support, and/or enhance one or more of operating system 838 and applications 839. Computer-executable instructions implemented by computer programs 837 also can be configured to provide one or more separate and/or stand-alone services.

Computing system 830 and/or computer programs 837 can implement and/or perform various aspects of the described subject matter. As shown, computer system 830 and/or computer programs 837 can include context menu code 840. In various embodiments, context menu code 840 can include computer-executable instructions that are stored on a computer-readable storage medium and configured to implement one or more aspects of the described subject matter. By way of example, and without limitation, context menu code 840 can implement context menu module 110, implement a context menu for an application user interface, and/or perform one or more aspects of computer-implemented method 700.

Computing device 810 and computer system 830 can communicate over network 850, which can be implemented by any type of network or combination of networks suitable for providing communication between computing device 810 and computer system 830. Network 850 can include, for example and without limitation: a WAN such as the Internet, a LAN, a telephone network, a private network, a public network, a packet network, a circuit-switched network, a wired network, and/or a wireless network. Computing device 810 and computer system 830 can communicate over network 850 using various communication protocols and/or data types. One or more communication interfaces 816 of computing device 810 and one or more communication interfaces 836 of computer system 830 can be employed in the context of communicating over network 850.

Computing device 810 and/or computer system 830 can communicate with a storage system 860 over network 850. Alternatively or additionally, storage system 860 can be integrated with computing device 810 and/or computer system 830. Storage system 860 can be representative of various types of storage in accordance with the described subject matter. Storage system 860 can provide any suitable type of data storage for relational (e.g., SQL) and/or non-relational (e.g., NO-SQL) data using database storage, cloud storage, table storage, blob storage, file storage, queue storage, and/or other suitable type of storage mechanism. Storage system 860 can be implemented by one or more computing devices, such as a computer cluster in a datacenter, by virtual machines, and/or provided as a cloud-based storage service.

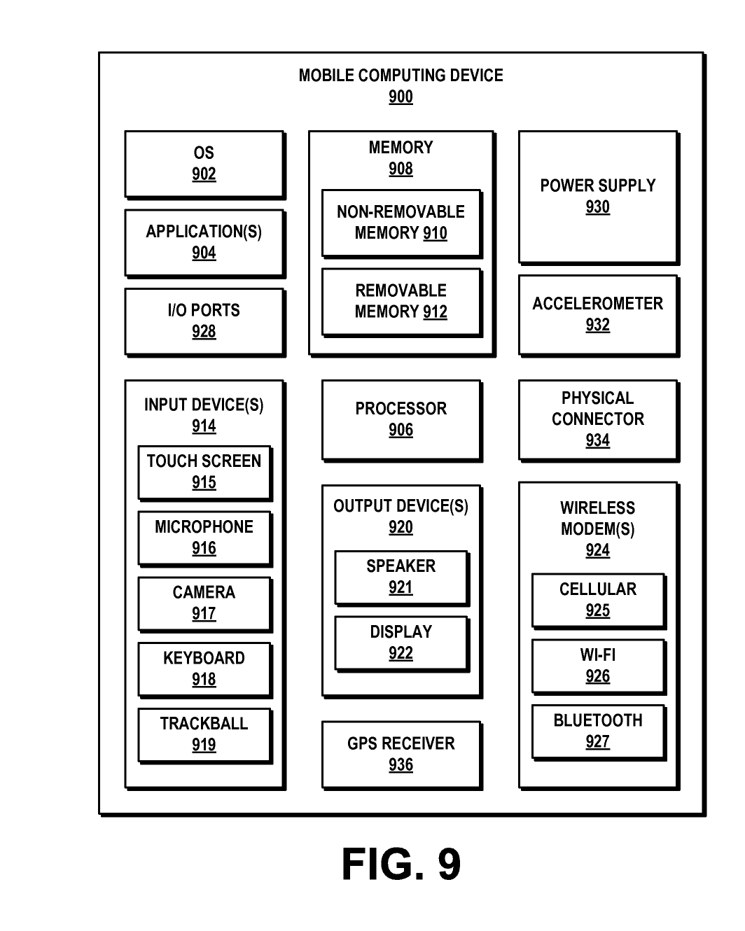

FIG. 9 illustrates a mobile computing device 900 as an embodiment of an exemplary mobile computing device that can implement aspects of the described subject matter. In various implementations, mobile computing device 900 can be an example of one or more of: client devices 102-104, touchscreen computing device 300, touchscreen computing device 400, touchscreen mobile computing device 600, and/or computing device 810.

As shown, mobile computing device 900 includes a variety of hardware and software components that can communicate with each other. Mobile computing device 900 can represent any of the various types of mobile computing device described herein and can allow wireless two-way communication over a network, such as one or more mobile communications networks (e.g., cellular and/or satellite network), a LAN, and/or a WAN.

Mobile computing device 900 can include an operating system 902 and various types of mobile application(s) 904. In some implementations, mobile application(s) 904 can include one or more client application(s) and/or components of context menu code 820 (e.g., context menu module 110).

Mobile computing device 900 can include a processor 906 (e.g., signal processor, microprocessor, ASIC, or other control and processing logic circuitry) for performing tasks such as: signal coding, data processing, input/output processing, power control, and/or other functions.

Mobile computing device 900 can include memory 908 implemented as non-removable memory 910 and/or removable memory 912. Non-removable memory 910 can include RAM, ROM, flash memory, a hard disk, or other memory device. Removable memory 912 can include flash memory, a Subscriber Identity Module (SIM) card, a “smart card” and/or other memory device.

Memory 908 can be used for storing data and/or code for running operating system 902 and/or mobile application(s) 904. Example data can include web pages, text, images, sound files, video data, or other data to be sent to and/or received from one or more network servers or other devices via one or more wired and/or wireless networks. Memory 908 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile computing device 900 can include and/or support one or more input device(s) 914, such as a touch screen 915, a microphone 916, a camera 917, a keyboard 918, a trackball 919, and other types of input devices (e.g., NUI device and the like). Touch screen 915 can be implemented, for example, using a capacitive touch screen and/or optical sensors to detect touch input. Mobile computing device 900 can include and/or support one or more output device(s) 920, such as a speaker 921, a display 922, and/or other types of output devices (e.g., piezoelectric or other haptic output devices). In some implementations, touch screen 915 and display 922 can be combined in a single input/output device.

Mobile computing device 900 can include wireless modem(s) 924 that can be coupled to antenna(s) (not shown) and can support two-way communications between processor 906 and external devices. Wireless modem(s) 924 can include a cellular modem 925 for communicating with a mobile communication network and/or other radio-based modems such as Wi-Fi modem 926 and/or Bluetooth modem 927. Typically, at least one of wireless modem(s) 924 is configured for: communication with one or more cellular networks, such as a GSM network for data and voice communications within a single cellular network; communication between cellular networks; or communication between mobile computing device 900 and a public switched telephone network (PSTN).

Mobile computing device 900 can further include at least one input/output port 928, a power supply 930, an accelerometer 932, a physical connector 934 (e.g., a USB port, IEEE 1394 (FireWire) port, RS-232 port, and the like), and/or a Global Positioning System (GPS) receiver 936 or other type of a satellite navigation system receiver. It can be appreciated the illustrated components of mobile computing device 900 are not required or all-inclusive, as various components can be omitted and other components can be included in various embodiments.

In various implementations, components of mobile computing device 900 can be configured to perform various operations in connection with aspects of the described subject matter. By way of example, and without limitation, mobile computing device 900 can implement context menu module 110, implement a context menu for an application user interface, and/or perform one or more aspects of computer-implemented method 700. Computer-executable instructions for performing such operations can be stored in a computer-readable storage medium, such as memory 908 for instance, and can be executed by processor 906.

### Supported Aspects

The detailed description provided above in connection with the appended drawings explicitly describes and supports various aspects in accordance with the described subject matter. By way of illustration and not limitation, supported aspects include computing device configured to provide a context menu in an application user interface, the computer system comprising: a processor configured to execute computer-executable instructions; and memory storing computer-executable instructions configured to: display a context indicator in response to user interaction that places an insertion pointer or selects content in the application user interface, wherein the context indicator is configured to invoke a floating menu having a set of contextual commands including a parent command that is configured to open a submenu having a plurality of submenu commands associated with the parent command; and display a selectable button appended to the context indicator, wherein the selectable button is configured to execute a predicted command that corresponds to one of a contextual command of the floating menu or a submenu command of the submenu.

Supported aspects include the forgoing computing device, wherein the memory further stores computer-executable instructions configured to determine the predicted command based on at least one of the user interaction or a prior command that was executed.

Supported aspects include any of the forgoing computing devices, wherein the memory further stores computer-executable instructions configured to determine the predicted command based on at least one of: a contextual command of the floating menu that is most-frequently used by a community of users, a contextual command of the floating menu that is most-frequently used by a user of the computing device, a submenu command of the submenu that is most-frequently used by the community of users, or a submenu command of the submenu that is most-frequently used by the user of the computing device.

Supported aspects include any of the forgoing computing devices, wherein the context indicator and the selectable button are configured to be dismissed or hidden by the floating menu upon selection of the context indicator.

Supported aspects include any of the forgoing computing devices, wherein submenu is configured to be opened as a callout from the floating menu upon selection of the parent button.

Supported aspects include any of the forgoing computing devices, wherein the floating menu is configured to be dismissed upon selection of the parent command button.

Supported aspects include any of the forgoing computing devices, wherein the submenu is configured to be anchored to the application user interface.

Supported aspects include any of the forgoing computing devices, wherein the submenu is configured to be opened as a floating user interface surface.

Supported aspects include any of the forgoing computing devices, wherein the memory further stores computer-executable instructions for displaying a virtual keyboard that is configured to be dismissed upon selection of the parent command button.

Supported aspects include any of the forgoing computing devices, wherein the memory further stores computer-executable instructions for displaying a virtual keyboard that is configured to be replaced by a toolbar upon switching orientation of the application user interface from a portrait view to a landscape view.

Supported aspects include any of the forgoing computing devices, wherein the memory further stores computer-executable instructions for displaying a virtual keyboard that is configured to show contextual commands of the floating menu on keys of the virtual keyboard.

Supported aspects further include an apparatus, a system, a computer-readable storage medium, a computer-implemented method, and/or means for implementing any of the foregoing computing devices or portions thereof.

Supported aspects include a computer-implemented method performed by a computing device to provide a context menu in an application user interface, the computer-implemented method comprising: detecting user interaction that places an insertion pointer or selects content in the application user interface; displaying a context indicator in the application user interface in response to the user interaction; and displaying a selectable button appended to the context indicator, wherein: the context indicator is configured to invoke a floating menu having a set of contextual commands including a parent command that is configured to open a submenu having a plurality of submenu commands associated with the parent command, and the selectable button is configured to invoke a predicted command that corresponds to one of a contextual command of the floating menu or a submenu command of the submenu.

Supported aspects include the forgoing computer-implemented method, further comprising determining the predicted command based on at least one of the user interaction or a prior command that was executed.

Supported aspects include any of the forgoing computer-implemented methods, further comprising determining the predicted command based on at least one of: a contextual command of the floating menu that is most-frequently used by a community of users, a contextual command of the floating menu that is most-frequently used by a user of the computing device, a submenu command of the submenu that is most-frequently used by the community of users, or a submenu command of the submenu that is most-frequently used by the user of the computing device.

Supported aspects include any of the forgoing computer-implemented methods, further comprising: dismissing or hiding the context indicator and the selectable button in response to selection of the context indicator; displaying the floating menu; and displaying the submenu in response to selection of the parent button.

Supported aspects include any of the forgoing computer-implemented methods, further comprising: dismissing the floating menu in response to the selection of the parent command button.

Supported aspects include any of the forgoing computer-implemented methods, further comprising: dismissing the floating menu and the submenu together in response to touch input that is outside of both the floating menu and the submenu.

Supported aspects further include an apparatus, a system, a computer-readable storage medium, and/or means for implementing and/or performing any of the foregoing computer-implemented methods or portions thereof.

Supported aspects include computer-readable storage medium storing computer-executable instructions that, when executed by a computing device, cause the computing device to implement a context menu configured to: display, in an application user interface, a context indicator and selectable button appended to the context indicator in response to user interaction that places an insertion pointer or selects content in the application user interface, wherein: the context indicator is configured to invoke a floating menu having a set of contextual commands including a parent command that is configured to open a submenu having a plurality of submenu commands associated with the parent command, and the selectable button is configured to invoke a predicted command that corresponds to one of a contextual command of the floating menu or a submenu command of the submenu.

Supported aspects include the foregoing computer-readable storage medium, wherein the context indicator and the selectable button are configured to be dismissed or hidden by the floating menu upon selection of the context indicator; and the floating menu is configured to be dismissed upon selection of the parent command button.

Supported aspects include any of the foregoing computer-readable storage media, wherein the predicted command is determined based on at least one of: the user interaction, a prior command that was executed, a contextual command of the floating menu that is most-frequently used by a community of users, a contextual command of the floating menu that is most-frequently used by a user of the computing device, a submenu command of the submenu that is most-frequently used by the community of users, or a submenu command of the submenu that is most-frequently used by the user of the computing device.

Supported aspects further include an apparatus, a system, a computer-implemented method, and/or means for implementing any of the foregoing computer-readable storage media or performing the functions thereof.

Supported aspects can provide various attendant and/or technical advantages in terms of improved efficiency and/or savings with respect to power consumption, memory, processor cycles, and/or other computationally-expensive resources.

The detailed description provided above in connection with the appended drawings is intended as a description of examples and is not intended to represent the only forms in which the present examples may be constructed or utilized.

It is to be understood that the configurations and/or approaches described herein are exemplary in nature, and that the described embodiments, implementations and/or examples are not to be considered in a limiting sense, because numerous variations are possible. The specific processes or methods described herein may represent one or more of any number of processing strategies. As such, various operations illustrated and/or described may be performed in the sequence illustrated and/or described, in other sequences, in parallel, or omitted. Likewise, the order of the above-described processes may be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computing device configured to provide a context menu in an application user interface, the computer system comprising:
a processor configured to execute computer-executable instructions; and
memory storing computer-executable instructions configured to:
display a context indicator in response to user interaction that places an insertion pointer or selects content in the application user interface, wherein the context indicator is configured to invoke a floating menu having a set of contextual commands including a parent command that is configured to open a submenu having a plurality of submenu commands associated with the parent command; and
display a selectable button appended to the context indicator, wherein the selectable button is configured to execute a predicted command that corresponds to one of a contextual command of the floating menu or a submenu command of the submenu.

2. The computing device of claim 1, wherein the memory further stores computer-executable instructions configured to determine the predicted command based on at least one of the user interaction or a prior command that was executed.

3. The computing device of claim 1, wherein the memory further stores computer-executable instructions configured to determine the predicted command based on at least one of:
a contextual command of the floating menu that is most-frequently used by a community of users,
a contextual command of the floating menu that is most-frequently used by a user of the computing device,
a submenu command of the submenu that is most-frequently used by the community of users, or
a submenu command of the submenu that is most-frequently used by the user of the computing device.

4. The computing device of claim 1, wherein the context indicator and the selectable button are configured to be dismissed or hidden by the floating menu upon selection of the context indicator.

5. The computing device of claim 1, wherein the submenu is configured to be opened as a callout from the floating menu upon selection of the parent button.

6. The computing device of claim 1, wherein the floating menu is configured to be dismissed upon selection of the parent command button.

7. The computing device of claim 6, wherein the submenu is configured to be anchored to the application user interface.

8. The computing device of claim 6, wherein the submenu is configured to be opened as a floating user interface surface.

9. The computing device of claim 1, wherein the memory further stores computer-executable instructions for displaying a virtual keyboard that is configured to be dismissed upon selection of the parent command button.

10. The computing device of claim 1, wherein the memory further stores computer-executable instructions for displaying a virtual keyboard that is configured to be replaced by a toolbar upon switching orientation of the application user interface from a portrait view to a landscape view.

11. The computing device of claim 1, wherein the memory further stores computer-executable instructions for displaying a virtual keyboard that is configured to show contextual commands of the floating menu on keys of the virtual keyboard.

12. A computer-implemented method performed by a computing device to provide a context menu in an application user interface, the computer-implemented method comprising:
detecting user interaction that places an insertion pointer or selects content in the application user interface;
displaying a context indicator in the application user interface in response to the user interaction; and
displaying a selectable button appended to the context indicator, wherein:
the context indicator is configured to invoke a floating menu having a set of contextual commands including a parent command that is configured to open a submenu having a plurality of submenu commands associated with the parent command, and
the selectable button is configured to invoke a predicted command that corresponds to one of a contextual command of the floating menu or a submenu command of the submenu.

13. The computer-implemented method of claim 12, further comprising determining the predicted command based on at least one of the user interaction or a prior command that was executed.

14. The computer-implemented method of claim 12, further comprising determining the predicted command based on at least one of:
a contextual command of the floating menu that is most-frequently used by a community of users,
a contextual command of the floating menu that is most-frequently used by a user of the computing device,
a submenu command of the submenu that is most-frequently used by the community of users, or
a submenu command of the submenu that is most-frequently used by the user of the computing device.

15. The computer-implemented method of claim 12, further comprising:
dismissing or hiding the context indicator and the selectable button in response to selection of the context indicator;
displaying the floating menu; and
displaying the submenu in response to selection of the parent button.

16. The computer-implemented method of claim 15, further comprising:
dismissing the floating menu in response to the selection of the parent command button.

17. The computer-implemented method of claim 15, further comprising:
dismissing the floating menu and the submenu together in response to touch input that is outside of both the floating menu and the submenu.

18. A computer-readable storage medium storing computer-executable instructions that, when executed by a computing device, cause the computing device to implement a context menu configured to:
display, in an application user interface, a context indicator and selectable button appended to the context indicator in response to user interaction that places an insertion pointer or selects content in the application user interface, wherein:
the context indicator is configured to invoke a floating menu having a set of contextual commands including a parent command that is configured to open a submenu having a plurality of submenu commands associated with the parent command, and
the selectable button is configured to invoke a predicted command that corresponds to one of a contextual command of the floating menu or a submenu command of the submenu.

19. The computer-readable storage medium of claim 18, wherein:
the context indicator and the selectable button are configured to be dismissed or hidden by the floating menu upon selection of the context indicator; and
the floating menu is configured to be dismissed upon selection of the parent command button.

20. The computer-readable storage medium of claim 18, wherein the predicted command is determined based on at least one of: the user interaction, a prior command that was executed, a contextual command of the floating menu that is most-frequently used by a community of users, a contextual command of the floating menu that is most-frequently used by a user of the computing device, a submenu command of the submenu that is most-frequently used by the community of users, or a submenu command of the submenu that is most-frequently used by the user of the computing device.
